(19) United States
(12) Patent Application Publication
(10) Pub. No.: US 2026/0141056 A1
(43) Pub. Date: May 21, 2026

(54) AUDIT LOGGING ACROSS NODES IN MULTI-NODE COMPUTING ENVIRONMENTS

(71) Applicant: NVIDIA Corporation, Santa Clara, CA (US)

(72) Inventors: Divya Vavili, Milpitas, CA (US); Smitesh Pawar, Seattle, WA (US)

(21) Appl. No.: 18/949,714

(22) Filed: Nov. 15, 2024

(51) Int. Cl. G06F 21/55

(52) U.S. Cl. CPC G06F 21/552; G06F 2221/034

(57) ABSTRACT

Apparatuses, systems, and techniques for audit logging across nodes of a computing environment are disclosed herein. First audit data associated with a first operation performed in accordance with a request by an application and second audit data associated a second operation performed in accordance with the request is obtained from is obtained from a first node and/or a second node of a computing environment. An audit log is updated to include a mapping between the first audit data, the second audit data, and an audit identifier associated with the request by the application. In response to an audit request for audit data associated with the request by the application, the first audit data and the second audit data are identified from the audit log based on the mapping and provided to a client device in accordance with the audit request.

### TECHNICAL FIELD

At least one embodiment pertains to audit logging of activity across nodes of a computing environment. For example, audit data can be obtained for two or more nodes of a computing environment. Computing resources of the two or more nodes can perform operations for respective objects in accordance with the request. An audit log can be updated to include a mapping between the audit data obtained from each respective node and an audit identifier associated with the request by the application. In response to an audit request, the audit data can be identified from the audit log based on the mapping and can be provided to a client device in accordance with the request.

### BACKGROUND

Many entities (e.g., organizations, corporations, government entities, etc.) utilize audit logs to document activities, events, changes, etc. in systems. An audit log refers to a record of activity within a system (e.g., a computing system). Records of an audit log can document a state (and/or changes to a state) of objects and/or data within the system. Audit logs and audit log management support compliance, accountability, and security within a system. It can be difficult for systems to effectively and accurately track related activities or events occurring at multiple nodes of a cloud-based system.

### BRIEF DESCRIPTION OF DRAWINGS

Various embodiments in accordance with the present disclosure will be described with reference to the drawings, in which:

FIG. 1 is a block diagram of an example system architecture, according to at least one embodiment;

FIG. 2 is a block diagram of an example audit engine, according to at least one embodiment;

FIG. 3 illustrates a flow diagram of an example method for audit logging across nodes of a computing environment, according to at least one embodiment;

FIGS. 4A-4B illustrate examples of audit logging across nodes of a computing environment, according to at least one embodiment;

FIG. 5 illustrates a flow diagram of another example method for audit logging across nodes of a computing environment, according to at least one embodiment;

FIG. 6A illustrates inference and/or training logic, according to at least one embodiment;

FIG. 6B illustrates inference and/or training logic, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments;

FIG. 11 illustrates at least portions of a graphics processor, according to one or more embodiments;

FIG. 12 is an example data flow diagram for an advanced computing pipeline, in accordance with at least one embodiment;

FIG. 13 is a system diagram for an example system for training, adapting, instantiating and deploying machine learning models in an advanced computing pipeline, in accordance with at least one embodiment; and

FIGS. 14A and 14B illustrate a data flow diagram for a process to train a machine learning model, as well as client-server architecture to enhance annotation tools with pre-trained annotation models, in accordance with at least one embodiment.

### DETAILED DESCRIPTION

An audit log refers to a record of activity within a computing system. In some instances, an audit log can document an occurrence of an event (e.g., performance of one or more operations for an object) at the computing system, a time at which the event occurred, an application or service that initiated the event, one or more entities or objects (e.g., variables, data structures, functions, methods, etc.) impacted by the event, a state of one or more objects before, during, and/or after the occurrence, and so forth. Such information is referred to as audit data herein. System administrators and/or security teams of the computing system can access the audit log to track the activity of the computing system, investigate security incidents or breaches, ensure compliance with regulatory requirements, and so forth.

In some instances, an application can run on one or more nodes of a computing environment. A node refers to a collection of computing resources, such as processing resources, memory resources, etc., that perform particular tasks associated with the application. In some instances, the tasks can be part of or can otherwise correspond to a microservice. A microservice refers to a modular and independently deployable software component that operates within a larger distributed application architecture. The microservice can encapsulate a specific functionality or task of an application. The application running on the one or more nodes can issue a request with respect to one or more objects associated with the application. One or more microservices (e.g., running on the one or more nodes of the computing environment) can perform operations for the objects in response to the request by the application. In an illustrative example, the application can issue a request with respect to a first object and a second object associated with the application. A first microservice running on one or more first nodes can execute a first operation for the first object, in response to the request, and a second microservice running on one or more second nodes can execute a second operation for the second object, in response to the request.

In some systems, audit data can be obtained for audit events (e.g., operations) performed at one or more nodes of a computing environment and added to an audit log associated with the one or more nodes. For example, when an application issues a request that is handled by one or more microservices, the respective nodes that run the microservices can generate audit data associated with the operations performed at the nodes in response to the request. However, conventional systems do not provide techniques that enable multiple nodes running multiple microservices invoked by a respective request to indicate that the operations performed by the microservices are in response to the same respective request. Accordingly, conventional systems do not allow for indicating a relation between audit events for a single request that are handled by multiple microservices across one or more nodes.

A user of the computing environment (e.g., a system administrator, a member of a security team) may conduct an audit of the application in the computing environment by accessing the audit log (e.g., using a client device) and evaluating the audit data to determine whether any security breaches have occurred, whether a failure has occurred, whether any system processes can be optimized, etc. As conventional systems do not allow for indicating the relation between audit events for a single request, as described above, the user may not be able to determine which audit events indicated by the audit log are associated with the same request, and therefore may be unable to determine a state of the computing environment before and/or after such audit events. For example, if a security breach or other serious failure has occurred during or based on a particular request issued by the application, the user may not be able to identify all of the microservices implicated by the particular request and therefore implicated in the security breach or failure based on the audit log data. Accordingly, the user may not be able to initiate any actions to adequately address the security breach or system failure, which can significantly impact the security of data (e.g., user data) in the computing environment and/or negatively impact a performance of the microservices (e.g., an efficiency, a latency, etc.) in the computing environment.

Embodiments of the present disclosure provide techniques for audit logging across nodes of a computing environment. In some embodiments, one or more microservices of an application can run using one or more nodes of the computing environment. The application can issue a request to perform operations with respect to one or more objects (e.g., in response to a user request via a client device, etc.). In an illustrative example, one or more first operations of the request can correspond to a first task that is associated with a first microservice of the computing environment. The request can be forwarded (e.g., by an edge device of the computing environment, etc.) to one or more first nodes associated with the first microservice and the first node(s) can perform one or more first operations for a first object in accordance with the request. The performance of the first operation(s) can be a first event, in some embodiments.

In some embodiments, an audit identifier (ID) associated with a request issued by an application can be provided with the request to node(s) for the microservice that handle tasks of the request. Before, after, or during the performance of the first operation(s), the first node(s) can determine whether the request includes an indication of the audit ID, e.g., by parsing a header and/or a payload of the request. In accordance with the previous illustrative example, the first microservice running on the first node(s) handles the initial tasks (e.g., the first tasks) of the request by the application. Accordingly, the first node(s) can determine whether the request includes an indication of the audit ID for the request, and, if so, can extract the audit ID from the request. If the audit ID is not included with the request, the first node(s) can generate the audit ID for the request. The first node(s) can provide the audit ID and first audit data associated with the first event to an audit manager. For example and without limitation, the first audit data may include information such as: an indication of the first operation(s) performed by the first microservice for a first object, a state of the first object prior to the performance of the first operation(s), a state of the first object after the performance of the first operation(s), etc. In one or more embodiments, the audit manager may be hosted on the first node or another computing system of the computing environment. In some embodiments, the audit manager can update an audit log associated with the nodes of the computing environment to include the first audit data associated with the first event and the audit ID. The audit log can include a mapping between the first event and the audit ID, in some embodiments.

In accordance with the previous illustrative example, one or more second operations of the request can correspond to a second task associated with a second microservice of the computing environment. One or more second node(s) running the second microservice can receive the request (e.g., from the first node(s), from the edge device, etc.). In some embodiments, the first node(s) can include the audit ID in the header and/or the payload of the request prior to forwarding the request to the second node(s). The second node(s) can perform the one or more second operations for a second object in accordance with the request. The performance of the second operation(s) can be a second event. The second node(s) can parse the request received from the first node(s) to determine whether the request includes an indication of the audit ID. In response to determining that the request includes the indication of the audit ID, the second node(s) can extract the audit ID from the request (e.g., from the header and/or the payload of the request). The second node(s) can provide the audit ID and second audit data associated with the second event (e.g., an indication of the second operation(s) performed by the second microservice for a second object, a state of the second object prior to the performance of the second operation(s), a state of the second object after the performance of the second operation(s), etc.) to the audit manager, as described above. The audit manager can update the audit log to include the second audit data and the audit ID. The audit log can include a mapping between the second event and the audit ID, in some embodiments.

In some embodiments, the audit manager can receive a request for audit data associated with the request issued by the application. The request can be received from a client device associated with a system administrator, a member of a security team, etc., in some embodiments. The audit manager can parse through the audit log to identify audit data that is mapped to the audit ID associated with the request. In accordance with the previous illustrative example, the audit manager can identify the first audit data and the second audit data mapped to the audit ID, in some embodiments. The audit manager can provide the first audit data and/or the second audit data to the client device associated with the system administrator, the member of the security team, etc., in response to the request for the audit data. Accordingly, the system administrator, security team member, etc. can access audit data for each task performed by microservices in accordance with a request using the audit log.

Aspects and embodiments of the present disclosure provide techniques to enable tracking of events across microservices running on nodes of a computing environment. As indicated herein, each request issued by an application is associated with a respective audit ID, which can be used to associate events for operations performed by different microservices in accordance with the request in the audit log. Accordingly, a user (e.g., a system administrator, a member of a security team, etc.) accessing the audit log can easily and quickly identify audit data associated with a particular request by the application and see the state of each microservice implicated by the request. This enables the user to more easily identify microservices that may be implicated in security breaches and/or experiencing (or at risk of experiencing) failures and implement protocols to address such security breaches and/or system failures in a more efficient and effective manger. Accordingly, the impact of security breaches and/or failures in a computing system can be significantly reduced, according to embodiments of the present disclosure, which can reduce the amount of time that system resources (e.g., computing resources, memory resources, etc.) are unavailable. The increased availability of system resources can increase an overall efficiency and decrease an overall latency of the computing environment.

Further, as described above, embodiments of the present disclosure provide that first node(s) that perform first operations of a first task associated with a request can forward an audit ID and first audit data to a second node(s) that perform second operations of a second task associated with the request. The second node(s) can forward the audit ID, the first audit data and second audit data to other node(s) that perform other operations of another task (e.g., if other tasks for the request are yet to be performed). Node(s) of the computing environment can continue to forward the audit ID and audit data generated for events at other nodes performing tasks of the request until each task of the request is complete. Upon completion of each task of the request, a node that performs the final set of operations for the request (e.g., to complete each task of the request) can transmit the audit ID and the audit data from each node involved in performing tasks of the request to the audit manager. Accordingly, the audit manager can receive the audit data for each operation performed in accordance with the request in a single notification or data packet, instead of in multiple notifications or data packets (e.g., from each individual node that performed operations in accordance with the request). As a fewer number of notifications or data packets are sent to the audit manager, a network bandwidth of the computing environment is increased, which can decrease the overall latency and increase the overall efficiency and throughput of the system.

Disclosed embodiments may be comprised in a variety of different systems such as systems for participating on online gaming, automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

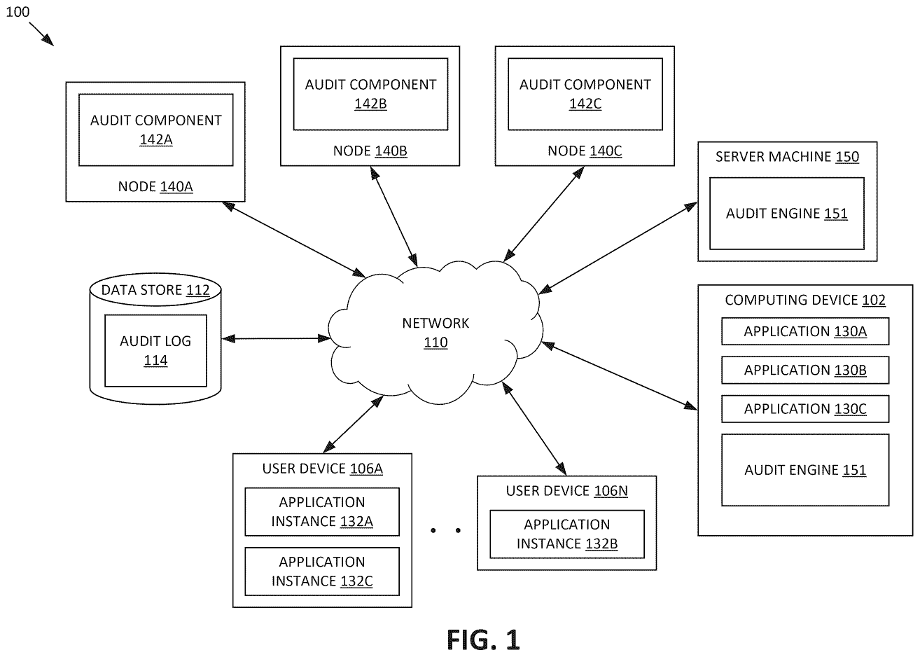

FIG. 1 is a block diagram of an example system architecture 100, according to at least one embodiment. The system architecture 100 (also referred to as “system” herein) includes a computing device 102, one or more user devices 106, one or more data stores 112 (collectively and individually referred to as data store 112 herein), one or more nodes 140 (e.g., node 140A, node 140B, node 140C, etc.), and/or a server machine 150 each connected by a network 110. In implementations, network 110 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

Computing device 102 may be a desktop computer, a laptop computer, a smartphone, a tablet computer, a server, or any suitable computing device capable of performing the techniques described herein. In some embodiments, computing device 102 may be a computing device of a cloud computing platform. For example, computing device 102 may be, or may be a component of, a server machine of a cloud computing platform. In such embodiments, computing device 102 may be coupled to one or more edge devices (not shown) via network 110. An edge device refers to a computing device that enables communication between computing devices at the boundary (e.g., interface) between two networks. For example, an edge device may be connected to computing device 102, user device(s) 106, data store 112, node(s) 140, and/or server machine 150 via network 110, and may be connected to one or more endpoint devices (not shown) via another network. In such example, the edge device can enable communication between computing device 102, data stores 112, node(s) 140, and/or server machine 150 and the one or more user devices 106. In other or similar embodiments, computing device 102 may be, or may be a component of, an edge device. For example, computing device 102 may facilitate communication between data stores 112, user device(s) 106, and/or server machine 150, which are connected to computing device 102 via network 110, and user device(s) 106 (or one or more other user devices and/or other computing devices) that are connected to computing device 102 via another network.

User device(s) 106 can include any computing device that enables users to access features of an application. For example, a user device 106 may be, or may be a component of, devices such as, but not limited to: televisions, smart phones, cellular telephones, personal digital assistants (PDAs), portable media players, netbooks, laptop computers, electronic book readers, tablet computers, desktop computers, set-top boxes, gaming consoles, autonomous vehicles, surveillance devices, and the like. In some embodiments, computing device 102 may be an edge device that connects user device(s) 106 to data stores 112, node(s) 140 and/or server machine 150. In other or similar embodiments, computing device 102 may not connect user device 106 to user device 106 to data stores 112, node(s) 140 and/or server machine 150 and instead may provide user device 106 with data obtained by computing device 102 from one or more of user device 106 to data stores 112, node(s) 140 and/or server machine 150. In additional or alternative embodiments, computing device 102 and user device 106 may be the same device and/or share the same or similar components.

In some embodiments, computing device 102 can host or otherwise provide access to one or more applications 130. An application refers to one or more computer programs designed to carry out a specific function for an end user or another application. In some embodiments, computing device 102 can be or otherwise correspond to a platform (e.g., an application hosting platform) that hosts one or more applications 130. An instance of an application 130 (e.g., application instance 132) hosted by computing device 102 can be provided to a user device 106 (e.g., via network 110). An application instance 132 refers to one or more processes of an application 130 that are performed or otherwise executed to provide access to features and/or functionality of the application 130. An application instance 132 can be run using computing resources (e.g., processing resources, memory resources, networking resources, etc.) of a user device 106 that is providing a user with access to the application 130 and/or other computing resources of a computing environment (e.g., computing resources of one or more nodes 140, as described herein). Computing device 102 can provide multiple user devices 106 with access to application instances 132 of an application 130 simultaneously (or approximately simultaneously). In an illustrative example, computing device 102 can host application 130A, application 130B and/or application 130C. An instance of application 130A (e.g., application instance 132A) and/or application 130C (e.g., application instance 132C) can be provided to user device 106A, in some embodiments. In other or similar embodiments, an instance of application 130B (e.g., application instance 132B) can be provided to user device 106N. It should be noted that although FIG. 1 depicts computing device 102 as hosting three applications, computing device 102 can host any number of applications 130. In other or similar embodiments, one or more of applications 130 can run on user devices 106.

As illustrated in FIG. 1, system 100 can include one or more nodes 140 (e.g., node 140A, node 140B, node 140C, etc.). A node refers to a grouping of hardware resources, software resources, etc., within a cloud computing environment. In some embodiments, a node can be associated with one or more microservices for an application 130 hosted by or otherwise associated with computing device 102. A microservice refers to a modular and independently deployable software component that operates within a larger distributed application architecture. Examples of microservices can include, but are not limited to, logic microservices (e.g., microservices that manage functionalities such as user authentication for an application 130, etc.), data microservices (e.g., microservices that manage databases or data storage for the application 130, handle tasks such as data retrieval, updating, and/or synchronization for the application 130, etc.), application programming interface (API) microservices (e.g., microservices that provides interfaces for communication between different components of application 130, within system 100 and/or outside of system 100), gateway microservices (e.g., microservices that manage access to entry points of an application 130, manage requests, load balancing, routing, etc., to other microservices, etc.), event-driven microservices (e.g., microservices that manage asynchronous events, triggering actions, updates, etc. for application 130), and so forth.

In some embodiments, each node 140 of system 100 can host or otherwise support one or more microservices for an application 130 of computing device 102. Each node 140 can perform particular tasks or functions associated with a supported microservice. In some embodiments, memory resources of a node 140 can store instructions and/or data associated with performing the particular tasks or functions associated with a microservice. In response to a request to perform the particular task or function (e.g., from computing device 102, from a user device 106, etc.), processing resources (e.g., a processing device, etc.) of node 140 can access the instructions and/or data associated with the microservice and can execute the instructions to perform the particular task or function. In other or similar embodiments, data store 112 can store instructions and/or data associated with one or more microservices hosted by one or more nodes 140. In response to a request to perform the particular task or function associated with a microservice, the processing resources of the supporting node 140 can access data store 112 (e.g., via network 110) and can execute the instructions to perform the particular task or function, as described above. It should be noted that the microservice architecture illustrated and described with respect to FIG. 1 is provided for purposes of example and illustration only. Embodiments of the present disclosure can be applied to any type of microservice architecture and/or any type of system that supports a microservice architecture.

In some embodiments, computing device 102 (and/or server machine 150 accessible to computing device via network 110) can include an audit engine 151. Audit engine 151 can include one or more components that maintain an audit log 114 of audit activity associated with applications 130 within system 100. As described herein, an audit log refers to a record of audit activity within (or outside of) a computing system. Audit activity refers to one or more events (“audit events”) that have occurred (or are occurring) within (or outside of) system 100. An audit event refers to a security-related occurrence of system 100. As indicated above, an audit event can occur within system 100 (e.g., at computing device 102, user device(s) 106, node(s) 140, etc.), in some embodiments. In other or similar embodiments, an audit event can occur outside of system 100. For example, a device or entity outside of system 100 can transmit a request to one or more devices or components of system 100. The transmission of the request to the one or more devices or components of system 100 can be an audit event, in some embodiments. In some embodiments, a system administrator and/or a security team for system 100 can provide audit engine 151 (or another component of system 100) with an indication of one or more types of audit events that are to be tracked or otherwise documented for system 100. In other or similar embodiments, audit engine 151 (or another component of system 100) can determine the one or more types of audit events that are to be tracked or otherwise documented for system 100 (e.g., based on historical activity of system 100, etc.). In yet other or similar embodiments, all activity pertaining to system 100 include an audit event that is tracked or documented using audit log 114, as described herein. In accordance with embodiments described herein, a request by an application 130 and/or an application instance 132 to perform one or more operations with respect to an object (e.g., a variable, data structure, function, method, etc.) and the performance of the one or more operations by a device or component of system 100 can correspond to a respective audit event.

In some embodiments, audit log 114 can include audit data that documents or otherwise indicates an occurrence of an audit event at system 100, a time during which the audit event occurred, an application or service that initiated the audit event, one or more entities or objects impacted by the audit event, a state of one or more objects before, during, and/or after the occurrence, and so forth. Audit log 114 can be or otherwise include a data structure (e.g., a table, etc.) that incudes one or more entries, each entry corresponding to a respective audit event, in some embodiments. It should be noted that although some embodiments of the present disclosure refer to audit log 114 as a data structure, audit log 114 can have any form that is suitable for storing and/or organizing audit data for system 100, as described herein. In some embodiments, a system administrator and/or a security team for system 100 can access entries of audit log 114 (e.g., via a user device 106 or another device of system 100) to track the activity of system 100, investigate security breaches, ensure compliance with regulatory requirements, etc. Further details regarding audit log 114 are provided herein.

In some embodiments, each node 140 of system 100 can include an audit component 142 that collects audit data for each audit event occurring or otherwise corresponding to the respective node 140. Upon detecting an audit event (or that an audit event is to be initiated) at a node 140, the audit component 142 residing at the node 140 can generate audit data associated with the audit event. The audit data can include an indication of the audit event, a time during which the audit event occurred, etc., as indicated above. The audit component 142 of the node 140 can provide the generated audit data to audit engine 151 (or to another node 140 of system 100, as described herein). Upon receiving the generated audit data, audit engine 151 can update audit log 114 to include the generated audit data for the audit event, in some embodiments.

As indicated above, an application 130 (or an application instance 132) can issue a request that one or more operations be performed with respect to an object. In some embodiments, the request can be issued in response to a user interaction with one or more elements of the application 130 (or the application instance 132). In other or similar embodiments, the request can be issued in response to a request from another application or component of system 100 (or outside of system 100) and/or in accordance with a functionality associated with application 130. In some embodiments, the operations of the request can correspond to tasks associated with two or more microservices of system 100. In an illustrative example, node 140A of system 100 can correspond to a data microservice and node 140B of system 100 can correspond to an API microservice. A request issued by application 130 and/or application instance 132 can include one or more operations that involve tasks associated with the data microservice and the API microservice. In some embodiments, computing device 102 (and/or a user device 106 running an application instance 132) can transmit the request (e.g., via network 110) to node 140A and/or node 140B for performance of the tasks of the request by the corresponding microservices of nodes 140A-B. As indicated above, the request sent to nodes 140 can correspond to an audit event that is to be tracked by audit engine 151 and/or audit component(s) 142) of nodes 140, as described herein.

In some embodiments, computing device 102 and/or user device 106 can transmit the request to node 140A and 140B (e.g., simultaneously, concurrently, etc.). Each of nodes 140A and 140B can perform operations pertaining to the respective tasks of the request. In some embodiments, each of nodes 140A and 140B can provide an outcome of the performance of the operations (e.g., an updated or generated variable or data structure, an output of a function, etc.) to application 130 and/or application instance 132. In other or similar embodiments, node 140A and/or node 140B can provide an outcome of the performance of the operations to another node 140 of system 100. For example, upon completion of the operations pertaining to the data microservice, node 140A can provide an outcome of the performance to node 140B (or another node 140). Before, during, or after the performance of the operations, audit component 142A and audit component 142B can generate audit data pertaining to the performance of the operations, as described above. In some embodiments, audit component 142A and audit component 142B can provide the generated audit data to audit engine 151. Audit engine 151 can update audit log 114 to include the audit data received from audit component 142A and audit component 142B. In some embodiments, audit engine 151 can further update audit log 114 to include a mapping between the audit data received from audit component 142A and audit component 142B to include an audit identifier corresponding to the request that initiated the performance of the operations at node 140A and node 140B. An audit identifier can be a unique identifier that is generated or otherwise allocated for audit data that is associated with operations performed by one or more microservices that perform operations pertaining to a single request from application 130 and/or application instance 132. Further details regarding the audit identifier are described herein.

In some embodiments, a request by an application 130 and/or application instance 132 can include operations pertaining to initial tasks to be performed by a microservice (e.g., associated with node 140A) and additional operations pertaining to subsequent tasks to be performed by another microservice (e.g., associated with node 140B) following completion of the operations pertaining to the initial tasks. Computing device 102 and/or user device 106 can forward the request to node 140A and audit component 142A can generate audit data associated with the performance of the operations pertaining to the initial tasks. Upon completion of the operations pertaining to the initial tasks, node 140A can forward the request, an outcome of the performance of the initial tasks, and, in some embodiments, the generated audit data to node 140B. Audit component 142B can generate additional audit data associated with the performance of the operations pertaining to the subsequent tasks at node 140B. Upon completion of the operations pertaining to the subsequent tasks, node 140B can transmit the outcome of the subsequent tasks and/or the initial tasks to the application 130 and/or the application instance 132 that issued the request. Audit component 142B can transmit the audit data for the initial tasks and the subsequent tasks to audit manager 151. Audit manager 151 can update audit log 114 to include the audit data received from audit component 142B and a mapping to an audit identifier corresponding to the request, as described above.

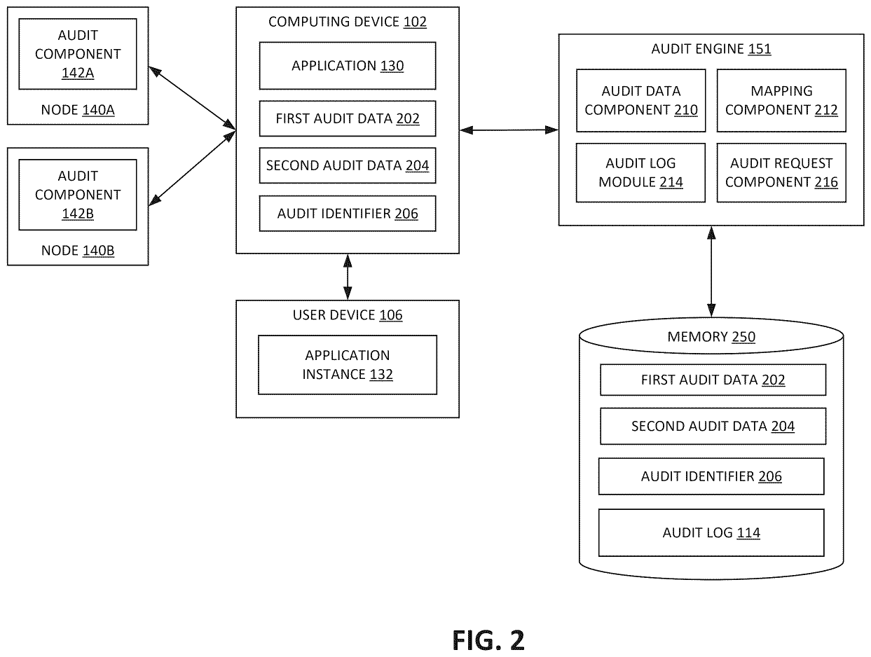

As indicated above, a system administrator and/or a security team for system 100 can access audit log 114 (e.g., via a user device 106 or another device of system 100) to evaluate activity within the system 100. In some instances, the system administrator and/or the security team can access the audit log 114 in response to a detection of a potential security alert or other such type of occurrence. In other or similar instances, the system administrator and/or the security team can access the audit log 114 as part of a routine (or semi-routine) protocol associated with system 100. In some instances, the system administrator and/or security team may wish to access audit data pertaining to operations of a request that invoked multiple microservices. The system administrator and/or security team can provide an indication of the request, microservices invoked by the request, a time period associated with the request, etc. via a user interface of user device 106 (or another device of system 100). Audit engine 151 can identify audit data of audit log 114 that corresponds to the indicated requests, microservices, time period etc. In some embodiments, audit engine 151 can determine, based on an audit identifier included in an entry associated with the identified audit data, that the identified audit data is related to other audit data of audit log 114. For example, a security administrator and/or security team can provide a request (e.g., via user device 106 or another device) for audit data pertaining to operations performed by a microservice of node 140A in accordance with a request from an application 130 and/or an application instance 132. Audit engine 151 can identify the audit data generated by audit component 142A for the operations performed by node 140A in audit log 114. Audit engine 151 can determine, based on a mapping to an audit identifier associated with the request, audit data generated by audit component 142B is associated with the audit event of the identified audit data. Audit engine 151 can extract the audit data generated by audit components 142A and 142B from audit log 114 and can provide the extracted audit data to the security administrator and/or the security team (e.g., via the user device 106 or another device). Accordingly, embodiments of the present disclosure provide techniques for providing security administrators and/or security teams with all audit data that is relevant or otherwise related to requested audit data, so to give the security administrator and/or security team a complete understanding of audit activity relating to an application request. Further details regarding audit engine 151, audit component 142, and audit log 114 are provided herein with respect to FIGS. 2-5.

In some implementations, computing device 102, user device 106, data store(s) 112, node(s) 140, and/or server machine 150, may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable assignment of execution of an application using various processing units of user device 106. It should be noted that in some other implementations, the functions of computing device 102, user device 106, node(s) 140, and/or server machine 150 may be provided by a fewer number of machines. For example, in some implementations, server machine 150 may be integrated into a single machine, while in other implementations server machine 150 may be integrated into multiple machines. In addition, in some implementations, server machine 150 may be integrated into computing device 102 and/or user device 106. In general, functions described in implementations as being performed by computing device 102 and/or server machine 150 may also be performed on one or more edge devices (not shown) and/or client devices (not shown), if appropriate. In addition, the functionality attributed to a particular component may be performed by different or multiple components operating together. Computing device 102 and/or server machines 150 may also be accessed as a service provided to other systems or devices through appropriate application programming interfaces.

FIG. 2 is a block diagram of an example audit engine 151, according to at least one embodiment. As described with respect to FIG. 1, audit engine 151 can reside at computing device 102 and/or at a server machine 150 of system 100. Audit engine 151 can be configured to manage audit data generated or otherwise obtained by audit components 142 residing at nodes 140 of system 100, as described herein. As illustrated in FIG. 2, audit engine 151 can include an audit data component 210, a mapping component 212, an audit log module 214, and/or an audit request component 216. In some embodiments, audit engine 151 and/or computing device 102 can be connected to a memory 250. Memory 250 can include or otherwise correspond to one or more regions of memory of data store 112, in some embodiments. In other or similar embodiments, memory 250 can include or otherwise correspond to other memory of or accessible by components of system 100.

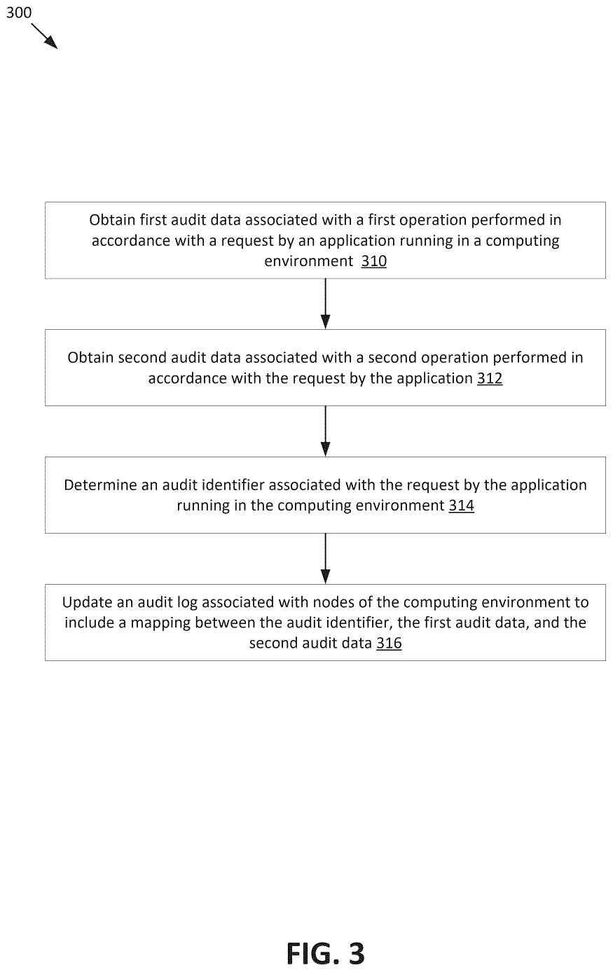

FIG. 3 illustrates a flow diagram of an example method 300 for audit logging across nodes of a computing environment, according to at least one embodiment. In some embodiments, method 300 can be performed by computing device 102. For example, one or more operations of method 300 can be performed by one or more components of audit engine 151, in some embodiments. Method 300 may be performed by one or more processing units (e.g., CPUs and/or GPUs), which may include (or communicate with) one or more memory devices. In at least one embodiment, method 300 may be performed by multiple processing threads (e.g., CPU threads and/or GPU threads), each thread executing one or more individual functions, routines, subroutines, or operations of the method. In at least one embodiment, processing threads implementing method 300 may be synchronized (e.g., using semaphores, critical sections, and/or other thread synchronization mechanisms). Alternatively, processing threads implementing method 300 may be executed asynchronously with respect to each other. Various operations of method 300 may be performed in a different order compared with the order shown in FIG. 3. Some operations of the methods may be performed concurrently with other operations. In at least one embodiment, one or more operations shown in FIG. 3 may not always be performed.

At block 310, processing logic obtains first audit data associated with a first operation performed for a first object in accordance with a request by an application running in a computing environment. At block 312, processing logic obtains second audit data associated with a second operation performed for a second object in accordance with the request by the application. As described above, computing device 102 can provide a user device 106 with access to an application 130 and/or an instance of application 130 (e.g., application instance 132). Application 130 and/or application instance 132 can issue one or more requests to perform operations pertaining to one or more tasks associated with a functionality of application 130. In some embodiments, a task can correspond to or be associated with a microservice (e.g., a data microservice, a logic microservice, etc.) that is hosted or otherwise supported by a node 140 of system 100. In some embodiments, a request issued by application 130 and/or application instance 132 can include operations pertaining to tasks corresponding to or associated with multiple microservices, as described above. For purposes of example and illustration only, a request issued by application 130 and/or application instance 132 can include operations pertaining to tasks of a first microservice hosted or supported by node 140A and operations pertaining to tasks for a second microservice hosted or supported by node 140B.

It should be noted that the request can include other operations pertaining to tasks of any number of microservices and that nodes 140 can host or support one or more of the microservices, in accordance with embodiments of the present disclosure. It should also be noted that for purposes of example and illustration only, some embodiments of the present disclosure refer to application 130 issuing a request that includes operations pertaining to tasks corresponding to or associated with one or more microservices. A person of ordinary skill in the art would understand that application instance 132 can additionally or alternatively issue such request, in accordance with embodiments of the present disclosure. Further, for purposes of example and illustration only, some embodiments of the present disclosure refer to computing device 102 transmitting requests issued by application 130 to node(s) 140. It should be noted that user device 106 can additionally or alternatively transmit such requests (e.g., as issued by application instance 132), in accordance with embodiments of the present disclosure.

As described above, computing device 102 can transmit the request to node 140A and/or node 140B. In some embodiments, computing device 102 can transmit the request to node 140A and node 140B (e.g., simultaneously, approximately simultaneously, concurrently, etc.). In other or similar embodiments, which are described in further detail below, computing device 102 can transmit the request to node 140A (e.g., without transmitting the request to node 140B). In some embodiments, a component or engine (not shown) of computing device 102 can determine that operations of the request correspond to tasks of microservices supported or hosted by node 140A and node 140B. For example, the request can involve retrieving data from a memory associated with application 130 and providing the data to another application 130 and/or application instance 132. The component or engine can identify operations associated with retrieving and providing the data and can identify (e.g., from information of data store 112, from other information associated with application 130) one or more microservices of system 100 that perform tasks pertaining retrieving and the providing. The component or engine can determine one or more nodes 140 of system 100 that support or host the identified microservices from the information or according to other techniques.

As indicated above, computing device 102 and can transmit the request to node 140A and node 140B. In some embodiments, computing device 102 can transmit an audit identifier 206 associated with the request to node 140A and node 140B. As described above, the audit identifier 206 can be unique to the request issued by application 130. In some embodiments, the audit identifier 206 can be or otherwise include a random sequence of alphanumeric characters. It should be noted that the audit identifier 206 can be or otherwise include any type of characters or symbols that make the audit identifier 206 from other audit identifiers 206. In one example, application 130 (or another component of computing device 102) can generate the audit identifier 206 prior to or subsequent to issuing the request. Computing device 102 can transmit the audit identifier 206 to node 140A and node 140B with the request, in some embodiments. For example, computing device 102 can include the audit identifier 206 in a header and/or a payload of a packet corresponding to the request. In other or similar embodiments, audit data component 210 can detect that application 130 has issued the request. For example, computing device 102 can transmit the request (or a notification indicating the request) to audit engine 151 in response to application 130 issuing the request. In response to detecting the request from application 130, audit data component 210 can generate audit identifier 206 and can provide the audit identifier 206 to computing device 102. Computing device 102 can transmit the audit identifier 206 with the request to node 140A and node 140B, in some embodiments. In other or similar embodiments, audit data component 210 can transmit the audit identifier 206 directly to node 140A and node 140B (e.g., separately from the request).

In other or similar embodiments, node 140A and/or node 140B can generate audit identifier 206. In an illustrative example, computing device 102 can transmit the request to node 140A and node 140B, as described above, in response to receiving the request, an audit component 142 residing at node 140A and/or node 140B can generate the audit identifier 206 prior to, during, or subsequent to performance of the operations of the request. In some embodiments, audit component 142A (e.g., residing at node 140A) can generate the audit identifier 206 (e.g., in accordance with a protocol of system 100) and can transmit the audit identifier 206 to audit component 42B (e.g., residing at node 140B) via network 110. In other or similar embodiments, audit component 142A can generate an audit identifier 206 and transmit the audit identifier 206 to audit identifier 142B. Audit component 142B can similarly generate an audit identifier 206 and transmit the audit identifier 206 to audit identifier 142A. If audit component 142A receives the audit identifier 206 generated by audit component 142B before receiving confirmation that the audit identifier 206 generated by audit component 142A has been received by audit component 142B, audit component 142A can disregard the audit identifier it generated and can store the audit identifier 206 generated by audit component 142B for association with the operations of the request.

As indicated above, node 140A and/or node 140B can perform operations of the request that correspond to tasks pertaining to a respective microservice supported or hosted by node 140A and/or node 140B. As also described above, audit component 142A residing at node 140A and audit component 142B node 140B can generate audit data pertaining to the performance of the operations at node 140A and node 140B in accordance with the request. In an illustrative example, node 140A can perform operations for tasks pertaining to a first microservice, in accordance with the request. Audit component 142A can generate audit data (e.g., first audit data 202) associated with the operations performed by node 140A. Similarly, node 140B can perform operations for tasks pertaining to a second microservice, in accordance with the request. Audit component 142B can generate audit data (e.g., second audit data 204) associated with the operations performed by node 140B. Audit component 142A and audit component 142B can transmit the first audit data 202 and the second audit data 204, respectively, audit engine 151 via network 110, in some embodiments. In some embodiments, audit component 142A and audit component 142B can include the audit identifier 206 with the first audit data 202 and the second audit data 204. Audit data component 210 of audit engine 151 can received the first audit data 202 and second audit data 204.

As indicated above, in some embodiments, computing device 102 can transmit a request issued by application 130 to node 140A (e.g., without transmitting the request to node 140B). In some embodiments, the request can include one or more first operations that pertain to tasks associated with a first microservice (e.g., supported by node 140A) and one or more second operations that pertain to tasks associated with a second microservice (e.g., supported by node 140B. The second operations can be performed subsequent to the first operations and/or can depend on an outcome (e.g., an output) of the performance of the first operations, in some embodiments. In other or similar embodiments, the second operations can be performed concurrently with the first operations and/or can be independent from an outcome of the performance of the first operations. In either embodiments, computing device 102 can transmit the request to node 140A (e.g., without transmitting the request to node 140B). The request can include an audit identifier 206 (e.g., generated by application 130, audit engine 151, etc.), in some embodiments. In other or similar embodiments, audit component 142A can generate the audit identifier 206 prior to, during, or subsequent to performance of the operations of the task pertaining to the first microservice. Audit component 142A can generate first audit data 202 associated with the performance of the operations, as described above.

In some embodiments, audit component 142A can transmit the first audit data 202 and the audit identifier 206 to audit component 142B residing at node 140B. In additional or alternative embodiments, node 140A can transmit (e.g., with or separate from the first audit data 202 and the audit identifier 206) an outcome of the performance of the operations of the task pertaining to the first microservice (e.g., an updated variable or data structure, an output of a function, etc.) to node 140B. Node 140B can perform the operations of the task pertaining to the second microservice, as described herein. In some embodiments, node 140B can perform the operations based on the outcome of the performance of the operations of the task pertaining to the first microservice. In other or similar embodiments, node 140B can perform the operations independent from the outcome of the performance of the operations of the task pertaining to the first microservice. Prior to, during, or subsequent to performance of the operations of the task pertaining to the second microservice, audit component 142B can generate second audit data 204 associated with the performance of the operations, as described above. In some embodiments, node 140B can determine that each operation of the request is completed. In such embodiments, node 140B can transmit an outcome of the operations performed by node 140A and/or node 140B to application 130, in accordance with the request. Audit component 142B can transmit the first audit data 202, the second audit data 204, and the audit identifier 206 to audit engine 151. In some embodiments, audit component 142B can transmit the first audit data 202 and the second audit data 204 in a single data packet. The audit identifier 206 can be included in a header or the payload of the data packet, as described above. In other or similar embodiments, audit component 142B can transmit the first audit data 202 and the second audit data 204 in respective data packets, each data packet including the audit identifier 206 in the header or payload of the data packets. Audit data component 120 can receive the data packet(s) from audit component 142B and can determine the audit identifier 206 associated with the first audit data 202 and the second audit data 204, as described above.

In other or similar embodiment, node 140B can determine that there are other operations of the request from application 130 that are to be performed by other nodes 140 (e.g., hosting or supporting other microservices) of system 100. In such embodiments, node 140B can transmit the first audit data 202, the second audit data 204, and the audit identifier 206 to the other nodes 140, as described above. In some embodiments, node 140B can transmit an outcome of the operations performed at node 140A and/or node 140B to the other nodes. Other nodes 140 can perform the operations, in accordance with previously described embodiments. In some embodiments, audit data component 210 can receive the first audit data 202, second audit data 204, and the audit identifier 206 from one or more other nodes 140 of system 100, as described herein.

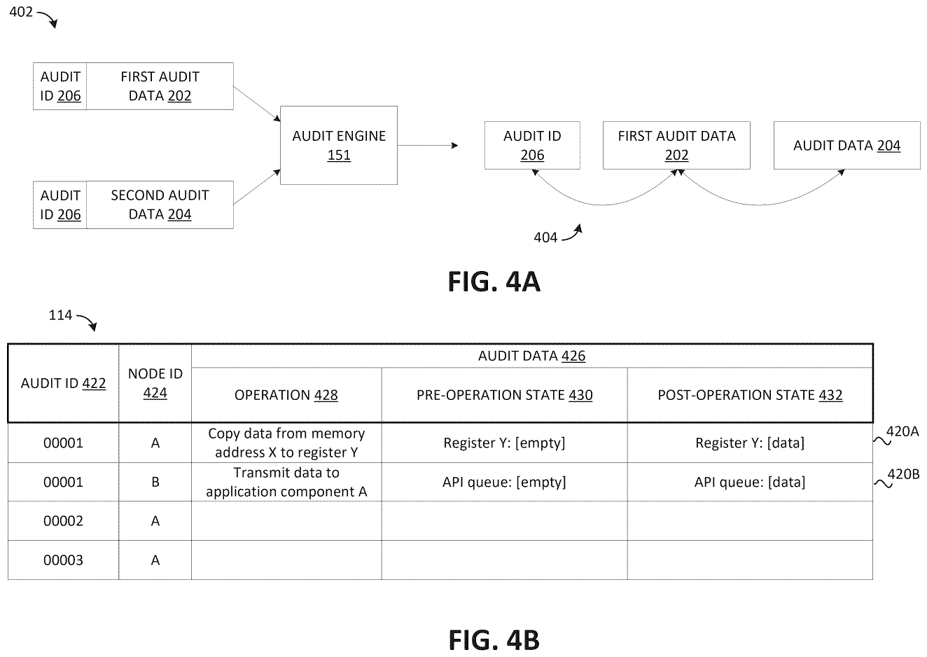

FIGS. 4A-4B illustrate examples of audit logging across nodes of a computing environment, according to at least one embodiment. As illustrated in FIG. 4A, audit engine 151 can receive one or more data packets 402 (e.g., from audit component 142A and/or audit component 142B). The data packet(s) 402 can include first audit data 202 (e.g., generated by audit component 142A) and an indication of audit identifier (ID) 206, in some embodiments. Additionally or alternatively, the data packet(s) 402 can include second audit data 204 (e.g., generated by audit component 142B) and an indication of audit identifier 206. As described above, first audit data 202, second audit data 204, and audit identifier 206 can be included in the same data packet 402, in some embodiments. In other or similar embodiments, first audit data 202 and audit identifier 206 can be included in a first data packet and second audit data 204 and audit identifier 206 can be included in a second data packet.

Referring back to FIG. 3, at block 314, processing logic determines an audit identifier associated with the request by the application running in the computing environment. As described above, audit component 142A and audit component 142B can include the audit identifier 206 (e.g., generated by application 130, audit engine 151, audit component 142A, audit component 142B, etc.) with first audit data 202 and second audit data 204, respectively. In an illustrative example, audit component 142A and/or audit component 142B can include the audit identifier 206 in a header and/or a payload of data packet(s) including the first audit data 202 and/or the second audit data 204 that is transmitted via network 110. In response to receiving the data packet(s), audit data component 210 can parse the data packet(s) (e.g., the header, the payload, etc.) to identify the audit identifier 206 associated with the first audit data 202 and/or the second audit data 204 and can extract the identified audit identifier 206 from the data packet. In some embodiments, audit engine 151 can receive a large number of data packets (e.g., tens, hundreds, thousands, etc.) from nodes 140 which include audit data pertaining to different requests from applications 130 hosted by computing device 102. Audit data component 210 can identify the audit data that generated per operations associated with a single request based on the inclusion of the audit identifier 206 in the data packets, as described herein. For example, audit data component 210 can determine that the first audit data 202 and the second audit data 204 were generated per operations associated with a common request from application 130 based on the audit identifier 206 included in data packets received from node 140A and node 140B.

Referring back to FIG. 3, at block 316, processing logic updates an audit log associated with nodes of the computing environment to include a mapping between the audit identifier, the first audit data, and the second audit data. In some embodiments, mapping component 212 can generate a mapping 404 between first audit data 202, second audit data 204, and audit identifier 206. A mapping can include any type of connection, relation, association, etc. between two or more data items. In some embodiments, mapping 404 can include a pointer (e.g., a variable that stores the memory address of another variable) between first audit data 202, second audit data 204, and/or audit identifier 206. The mapping 404 can be stored or otherwise included in audit log 114, in accordance with embodiments described herein.

FIG. 4B illustrates an example audit log 114, according to at least one embodiment. As illustrated in FIG. 4B, audit log 114 can be or otherwise correspond to a data structure (e.g., a table, etc.). However, as noted above, audit log 114 can have any other type of format that is suitable for logging audit data. In some embodiments, each entry 420 of audit log 114 can include one or more fields. For example, each entry 420 of audit log 114 can include an audit ID field 422, a node ID field 424, and one or more audit data fields 426. Each audit data field 426 can include one or more sub-fields that include one or more portions of the audit data. For example, an audit data field 426 can include an operation sub-field 428, a pre-operation state sub-field 430, a post-operation state sub-field 432, and so forth.

According to previous illustrative example, a first microservice supported or hosted by node 140A can be a data microservice and a second microservice supported or hosted by node 140B can be an API microservice. Node 140A can perform operations associated with managing and/or retrieving data in response to a request from an application 130. Node 140B can perform operations associated with a communication interface between components of application 130 and/or other applications. Application 130 can issue a request to provide data items to an application component A. Operations of the request can involve retrieving the data items (e.g., from a region of a memory), copying the data items to a particular register associated with application 130 (e.g., of node 140A, of node 140B, of user device 106, etc.) and transmitting the data items to the application component A (e.g., using an API of application 130). The data microservice at node 140A can perform operations pertaining to the retrieving and copying tasks and the API microservice at node 140B can perform operations pertaining to the transmitting task.

Audit engine 151 can obtain first audit data 202 corresponding to the operations pertaining to the retrieving and copying tasks and second audit data 204 corresponding to the operations pertaining to the transmitting task, as described above. Audit data component 210 can determine that the first audit data 202 and the second audit data 204 is associated with the same request from application 130 based on the common audit identifier 206, as described above. Mapping component 212 can therefore generate the mapping 404 between the first audit data 202 and the second audit data 204, as described above.

Audit log module 214 can update audit log 114 to include the mapping between the first audit data 202, the second audit data 204, and the audit identifier 206. For example, as illustrated in FIG. 4B, audit log module 214 can update a first entry 420A of audit log 114 to include first audit data 202 (e.g., in audit data field(s) 426) and audit identifier 206 (e.g., in audit identifier field 422). In some embodiments, audit log module 214 can further update the first entry 420A to include an indication of the node that performed operations associated with the first audit data 202 (e.g., node “A). Audit log module 214 can update a second entry 420B of audit log 114 to include second audit data 204 (e.g., in audit data field(s) 426) and audit identifier 206 (e.g., in audit identifier field 422). Audit log module 214 can also update the second entry 420B to include an indication of the node that performed operations associated with the second audit data 204 (e.g., in audit data field(S) 426). In some embodiments, the common audit identifier 206 indicated by audit ID field 422 of entry 420A and 420B can correspond to a mapping that indicates a relation between first audit data 202 and second audit data 204. In other or similar embodiments, audit log module 214 can update audit log 114 to include another type of mapping (e.g., a pointer, etc.) between first audit data 202 and second audit data 204, as described herein.

It should be noted that although audit log 114 of FIG. 4B is depicted as including operation sub-field 428, pre-operation state sub-field 430, and post-operation state sub-field 432 as part of audit data field 426, audit data field 426 (or any other field of audit log 114) can include any other types of audit data associated with operations performed at nodes 140. For example, audit log 114 can include fields that indicate a tenant associated with an operation performed according to a request of an application 130, a particular application 130 that initiate the request that involved the operation, a timestamp for an initiation and/or completion of the operation, an identifier for a particular machine or component of the machine that performed the operation, a type of the operation, an actor that initiated the request by application 130, a location of the actor that initiated the request, a subject of the request by application 130, a location of the subject of the request, an identifier for an object that is involved with the operation of the request, a location of the object involved with the operation, a summarization of a state change of the object involved with the operation, data accessed during performance of the operation, and/or other data or information associated with the operation or the request.

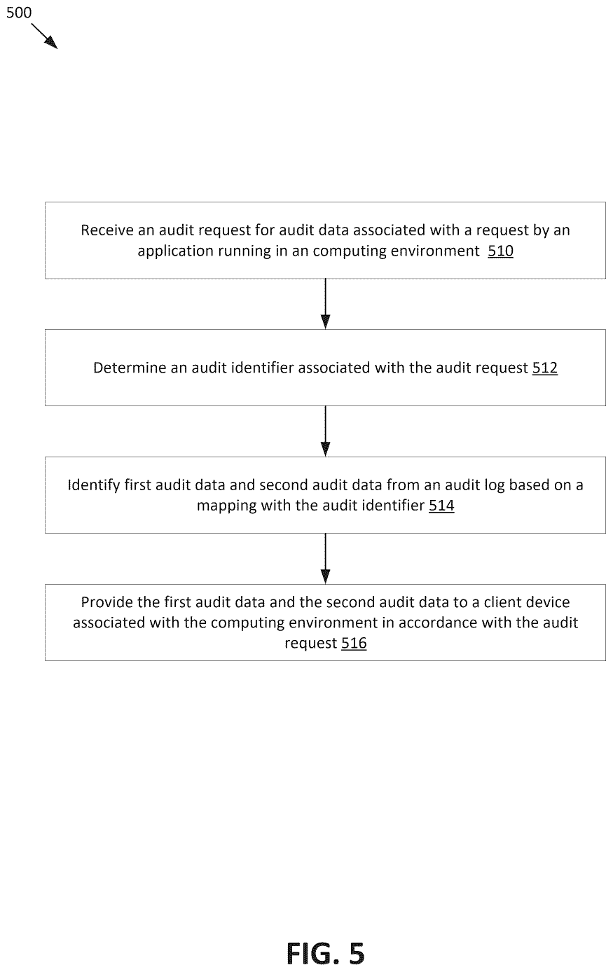

FIG. 5 illustrates a flow diagram of another example method 500 for audit logging across nodes of a computing environment, according to at least one embodiment. In some embodiments, method 500 can be performed by computing device 102. For example, one or more operations of method 500 can be performed by one or more components of audit engine 151, in some embodiments. Method 500 may be performed by one or more processing units (e.g., CPUs and/or GPUs), which may include (or communicate with) one or more memory devices. In at least one embodiment, method 500 may be performed by multiple processing threads (e.g., CPU threads and/or GPU threads), each thread executing one or more individual functions, routines, subroutines, or operations of the method. In at least one embodiment, processing threads implementing method 500 may be synchronized (e.g., using semaphores, critical sections, and/or other thread synchronization mechanisms). Alternatively, processing threads implementing method 500 may be executed asynchronously with respect to each other. Various operations of method 500 may be performed in a different order compared with the order shown in FIG. 5. Some operations of the methods may be performed concurrently with other operations. In at least one embodiment, one or more operations shown in FIG. 5 may not always be performed.

At block 510, processing logic receives an audit request for audit data associated with a request by an application running in a computing environment. In some embodiments, audit request component 216 can receive the request for the audit data. In some embodiments, the request can be received from a user device 106 and/or another device of or connected to system 100 that is associated with a system administrator and/or a security team for system 100. The request can be received in response to a detection (e.g., by another component of system 100) of a potential security event (e.g., a security breach), in some embodiments. In other or similar embodiments, the request can be received in accordance with a routine security audit protocol for system 100.

In some embodiments, the audit request can be for access to audit data pertaining to a particular operation or request by application 130. In such embodiments, the audit request can indicate the operation or the request and/or data or functions pertaining to the operation or the request. In other or similar embodiments, the audit request can be for access to audit data for operations performed during a particular time period. In such embodiments, the audit request can indicate the time period of which the audit data is requested. In yet other or similar embodiments, the audit request can be for access to audit data associated with operations performed by a particular node 140 (or group of nodes 140). In such embodiments, the audit request can include an indication of the particular node 140 (or group of nodes 140) for which the audit data is requested. In yet other or similar embodiments, the audit request can be for access to audit data associated with all operations performed for a particular application 130. In such embodiments, the audit request can include an indication of the particular application 130 for which audit data is requested.

At block 512, processing logic determines an audit identifier associated with the audit request. As indicated above, the audit request can indicate an operation or request of application 130 and/or data or functions pertaining to the operation or the request, a time period of which audit data is requested, a particular node 140 (or group of nodes 140) for which audit data is requested, and so forth. In some embodiments, audit request component 216 of audit engine 151 can access audit log 114 to identify data or information that pertains to information of the request. For example, audit request component 216 can identify an entry 420 of audit log 114 that includes audit data obtained for a particular operation or request indicated by the audit request, a timestamp that falls within the time period indicated by the request, an identifier for a node 140 indicated by the request and so forth. Audit request component 216 can determine the audit identifier 206 associated with the audit data of the identified entry 420 based on a value included in the audit ID field 422 of the identified entry 420. In accordance with one or more previous illustrative examples, the audit request can pertain to audit data for operations performed by node 140A. Audit request component 216 can identify entry 420A of audit log 114 as including first audit data 202 pertaining to one or more operations performed by node 140A based on a value of node ID field 424 of entry 420A. Audit request component 422 can determine that the audit identifier 206 for the first audit data 202 is “00001” based on a value of audit ID field 422 of entry 420A.

At block 514, processing logic identifies first audit data and second audit data from an audit log based on a mapping with the audit identifier. As described above, audit log 114 can include a mapping between two or more sets of audit data based on an association of the sets of audit data with a common audit identifier 206. In accordance with one or more previous illustrative examples, audit log 114 can include a mapping between first audit data 202 (e.g., generated by audit component 142A of node 140A) and second audit data 204 (e.g., generated by audit component 142B of node 140B) based on an association of first audit data 202 and second audit data 204 with common audit identifier 206, as described above. In response to determining the audit identifier 206 associated with first audit data 202, as described with respect to block 516, audit request component 216 can determine whether any other entries 420 of audit log 114 have a common audit identifier 206 with the first audit data 202. In some embodiments, audit request component 216 can determine whether other entries 420 have the common audit identifier 206 by parsing through the audit ID field 422 of entries 420 to determine whether values of the audit ID field 422 correspond to the value of the audit ID field 422 of entry 420B. In accordance with previous illustrative examples, audit request component 216 can determine that a value of the audit ID field 422 of entry 420B (e.g., “00001”) corresponds to the value of the audit ID field 422 of entry 420A (e.g., “00001”). Accordingly, audit request component 216 can determine that first audit data 202 (e.g., included in audit data field 426 of entry 420A) corresponds to second audit data 204 (e.g., included in audit data field 426 of entry 420B.

At block 516, processing logic provides the first audit data and the second audit data to a client device associated with the computing environment in accordance with the audit request. Audit request component 216 can extract the first audit data 202 and the second audit data 204 from entries 420A and 420B and can provide the extracted first audit data 202 and second audit data 204 to user device 106 (or the other device of system 100) associated with the system administrator and/or security team of system 100. Accordingly, audit engine 151 can provide system administrators and/or security teams of a system with audit data that is relevant to an audit request, even if a portion of the audit data is not explicitly requested or referenced by the audit request. As such, system administrators and/or security teams can initiate appropriate action within system 100 (e.g., to mitigate or stop a security breach, etc.) quickly and effectively.

### Inference and Training Logic

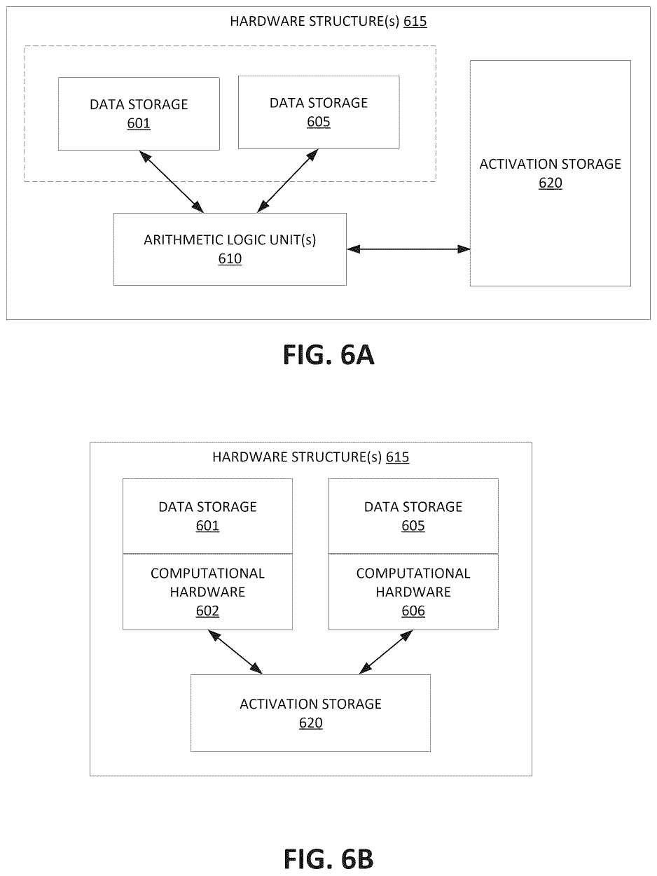

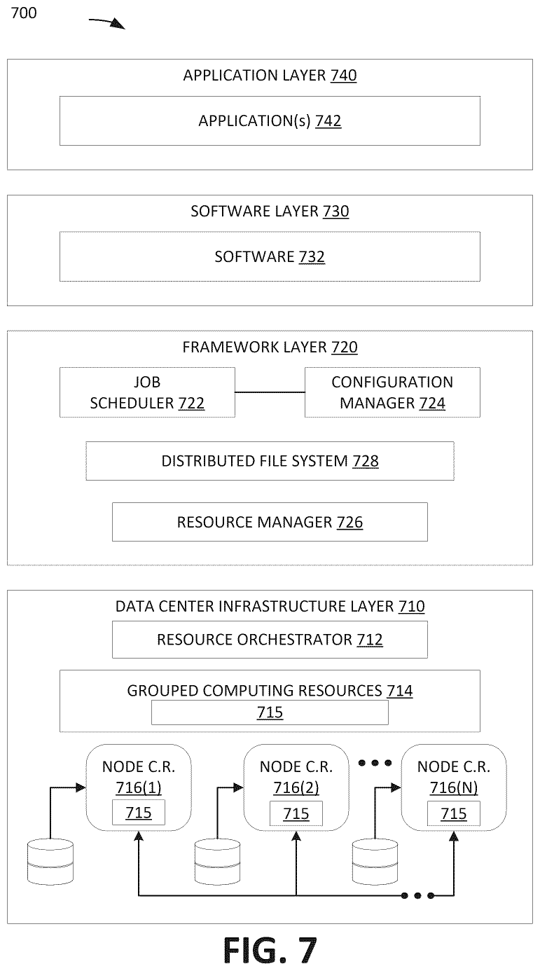

FIG. 6A illustrates hardware structure(s) 615 for inference and/or training logic used to perform inferencing and/or training operations associated with one or more embodiments. Details regarding inference and/or training logic are provided below in conjunction with FIGS. 6A and/or 6B.

In at least one embodiment, hardware structure(s) 615 may include, without limitation, code and/or data storage 601 to store forward and/or output weight and/or input/output data, and/or other parameters to configure neurons or layers of a neural network trained and/or used for inferencing in aspects of one or more embodiments. In at least one embodiment, training logic may include, or be coupled to code and/or data storage 601 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 601 may be included with other on-chip or off-chip data storage, including a processor's L1, L2, or L3 cache or system memory.

In at least one embodiment, any portion of code and/or data storage 601 may be internal or external to one or more processors or other hardware logic devices or circuits. In at least one embodiment, code and/or code and/or data storage 601 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, hardware structure(s) 615 may include, without limitation, a code and/or data storage 605 to store backward and/or output weight and/or input/output data corresponding to neurons or layers of a neural network trained and/or used for inferencing in aspects of one or more embodiments. In at least one embodiment, code and/or data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic may include, or be coupled to code and/or data storage 605 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 605 may be included with other on-chip or off-chip data storage, including a processor's L1, L2, or L3 cache or system memory. In at least one embodiment, any portion of code and/or data storage 605 may be internal or external to on one or more processors or other hardware logic devices or circuits. In at least one embodiment, code and/or data storage 605 may be cache memory, DRAM, SRAM, non-volatile memory (e.g., Flash memory), or other storage. In at least one embodiment, choice of whether code and/or data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 601 and code and/or data storage 605 may be separate storage structures. In at least one embodiment, code and/or data storage 601 and code and/or data storage 605 may be same storage structure. In at least one embodiment, code and/or data storage 601 and code and/or data storage 605 may be partially same storage structure and partially separate storage structures. In at least one embodiment, any portion of code and/or data storage 601 code and/or data storage 605 may be included with other on-chip or off-chip data storage, including a processor's L1, L2, or L3 cache or system memory.

In at least one embodiment, hardware structure(s) 615 may include, without limitation, one or more arithmetic logic unit(s) (“ALU(s)”) 610, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 620 that are functions of input/output and/or weight parameter data stored in code and/or data storage 601 and/or code and/or data storage 605. In at least one embodiment, activations stored in activation storage 620 are generated according to linear algebraic and or matrix-based mathematics performed by ALU(s) 610 in response to performing instructions or other code, wherein weight values stored in code and/or data storage 605 and/or code and/or data storage 601 are used as operands along with other values, such as bias values, gradient information, momentum values, or other parameters or hyperparameters, any or all of which may be stored in code and/or data storage 605 or code and/or data storage 601 or another storage on or off-chip.

In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 601, code and/or data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, hardware structure(s) 615 and/or inference and/or training logic illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, hardware structure(s) and/or inference and/or training logic of FIG. 6A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 6B illustrates hardware structure(s) 615 for inference and/or training logic, according to at least one or more embodiments. In at least one embodiment, hardware structure(s) 615 may include, without limitation, hardware logic in which computational resources are dedicated or otherwise exclusively used in conjunction with weight values or other information corresponding to one or more layers of neurons within a neural network. In at least one embodiment, hardware structure(s) 615 and/or inference and/or training logic of FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, hardware structure(s) 615 and/or inference and/or training logic of FIG. 6B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic includes, without limitation, code and/or data storage 601 and code and/or data storage 605, which may be used to store code (e.g., graph code), weight values and/or other information, including bias values, gradient information, momentum values, and/or other parameter or hyperparameter information. In at least one embodiment illustrated in FIG. 6B, each of code and/or data storage 601 and code and/or data storage 605 is associated with a dedicated computational resource, such as computational hardware 602 and computational hardware 606, respectively. In at least one embodiment, each of computational hardware 602 and computational hardware 606 comprises one or more ALUs that perform mathematical functions, such as linear algebraic functions, only on information stored in code and/or data storage 601 and code and/or data storage 605, respectively, result of which is stored in activation storage 620.

In at least one embodiment, each of code and/or data storage 601 and 605 and corresponding computational hardware 602 and 606, respectively, correspond to different layers of a neural network, such that resulting activation from one “storage/computational pair 601/602” of code and/or data storage 601 and computational hardware 602 is provided as an input to “storage/computational pair 605/606” of code and/or data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic.

### Data Center

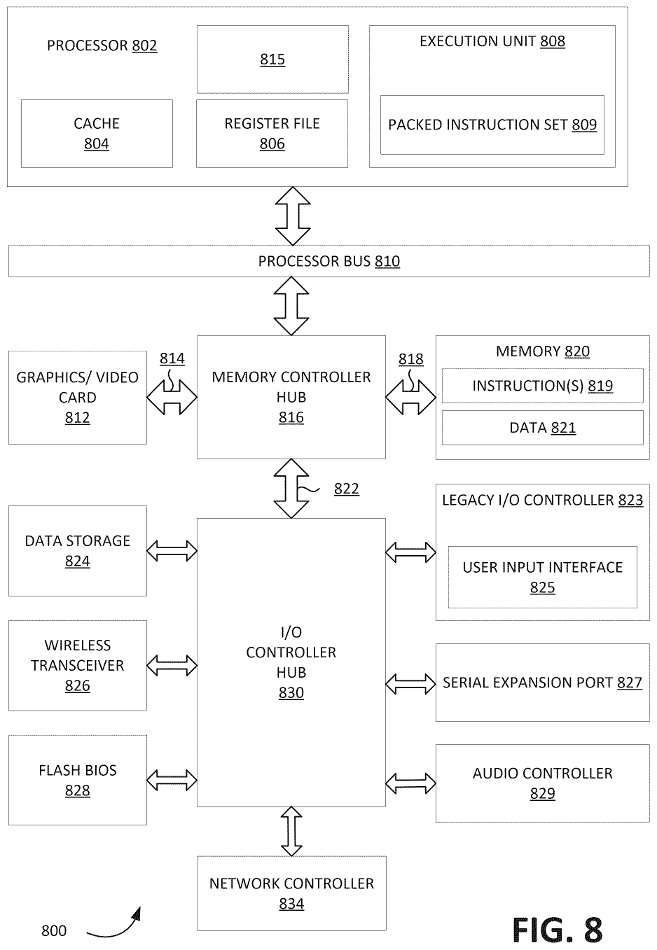

FIG. 7 illustrates an example data center 700, in which at least one embodiment may be used. In at least one embodiment, data center 700 includes a data center infrastructure layer 710, a framework layer 720, a software layer 730, and an application layer 1240.

In at least one embodiment, as shown in FIG. 7, data center infrastructure layer 710 may include a resource orchestrator 712, grouped computing resources 714, and node computing resources (“node C.R.s”) 616(1)-616(N), where “N” represents any whole, positive integer. In at least one embodiment, node C.R. s 616(1)-616(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 616(1)-616(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 616(1)-616(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 616(1)-616(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic are used to perform inferencing and/or training operations associated with one or more embodiments. Details regarding inference and/or training logic are provided in conjunction with FIGS. 6A and/or 6B. In at least one embodiment, inference and/or training logic may be used in system FIG. 7 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

### Computer Systems

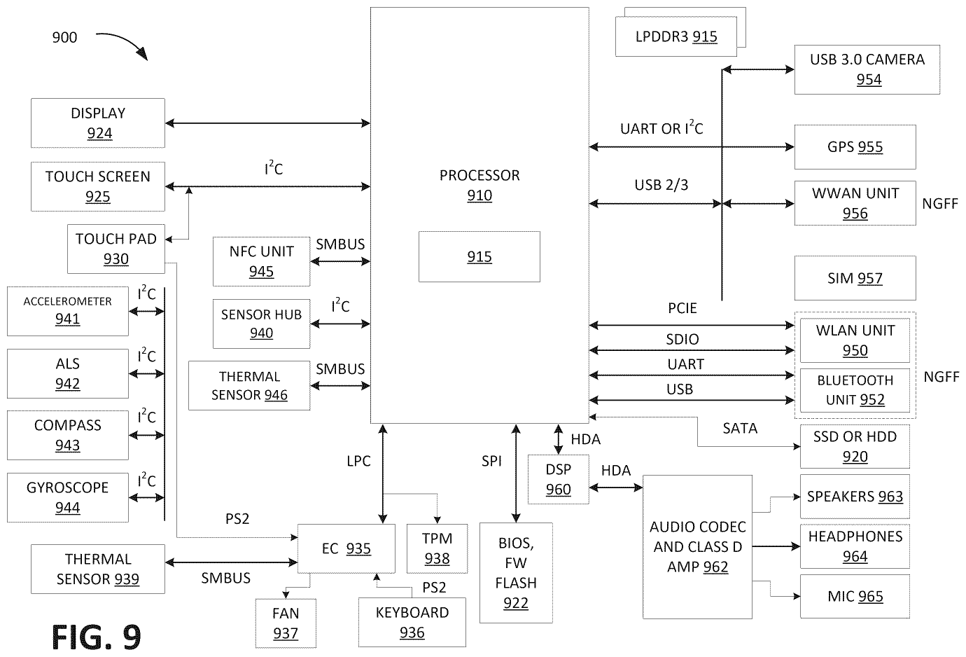

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834, which may include in some embodiments, a data processing unit. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips,” whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Inference and/or training logic 615 are used to perform inferencing and/or training operations associated with one or more embodiments. Details regarding inference and/or training logic 615 are provided below in conjunction with FIGS. 6A and/or 6B. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

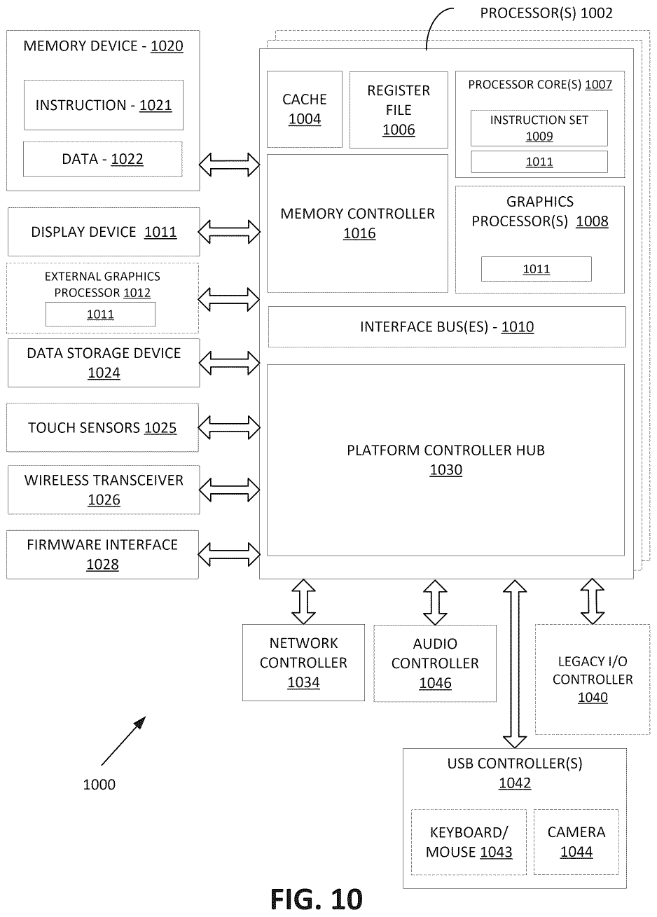

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, system 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips,” whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Inference and/or training logic 615 are used to perform inferencing and/or training operations associated with one or more embodiments. Details regarding inference and/or training logic 615 are provided below in conjunction with FIGS. 6A and/or 6B. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

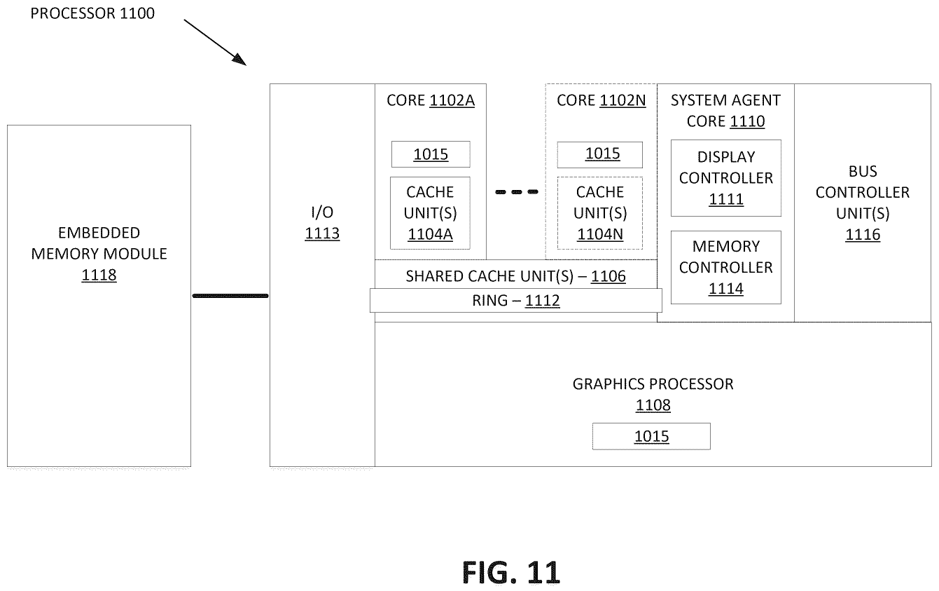

FIG. 10 is a block diagram of a processing system, according to at least one embodiment. In at least one embodiment, system 1000 includes one or more processors 1002 and one or more graphics processors 1008, and may be a single processor desktop system, a multiprocessor workstation system, or a server system having a large number of processors 1002 or processor cores 1007. In at least one embodiment, system 1000 is a processing platform incorporated within a system-on-a-chip (SoC) integrated circuit for use in mobile, handheld, edge, or embedded devices.

In at least one embodiment, system 1000 may include, or be incorporated within a server-based gaming platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 may also include, couple with, or be integrated within a wearable device, such as a smart watch wearable device, smart eyewear device, augmented reality device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor cores 1007 may each process a different instruction set 1009, which may include instructions to facilitate emulation of other instruction sets. In at least one embodiment, processor core 1007 may also include other processing devices, such a Digital Signal Processor (DSP).

In at least one embodiment, processor 1002 includes cache memory 1004. In at least one embodiment, processor 1002 may have a single internal cache or multiple levels of internal cache. In at least one embodiment, cache memory is shared among various components of processor 1002. In at least one embodiment, processor 1002 also uses an external cache (e.g., a Level-3 (L3) cache or Last Level Cache (LLC)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in system 1000. In at least one embodiment, interface bus 1010, in one embodiment, may be a processor bus, such as a version of a Direct Media Interface (DMI) bus. In at least one embodiment, interface 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 may be a dynamic random access memory (DRAM) device, a static random access memory (SRAM) device, flash memory device, phase-change memory device, or some other memory device having suitable performance to serve as process memory. In at least one embodiment memory device 1020 may operate as system memory for system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 may connect to processor(s) 1002. In at least one embodiment display device 1011 may include one or more of an internal display device, as in a mobile electronic device or a laptop device or an external display device attached via a display interface (e.g., DisplayPort, etc.). In at least one embodiment, display device 1011 may include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 may connect via a storage interface (e.g., SATA) or via a peripheral bus, such as a Peripheral Component Interconnect bus (e.g., PCI, PCI Express). In at least one embodiment, touch sensors 1025 may include touch screen sensors, pressure sensors, or fingerprint sensors. In at least one embodiment, wireless transceiver 1026 may be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and may be, for example, a unified extensible firmware interface (UEFI). In at least one embodiment, network controller 1034 may enable a network connection to a wired network. In at least one embodiment, a high-performance network controller (not shown) couples with interface bus 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 may also connect to one or more Universal Serial Bus (USB) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1011. In at least one embodiment, platform controller hub 1030 and/or memory controller 1016 may be external to one or more processor(s) 1002. For example, in at least one embodiment, system 1000 may include an external memory controller 1016 and platform controller hub 1030, which may be configured as a memory controller hub and peripheral controller hub within a system chipset that is in communication with processor(s) 1002.

Inference and/or training logic 615 are used to perform inferencing and/or training operations associated with one or more embodiments. Details regarding inference and/or training logic 615 are provided below in conjunction with FIGS. 6A and/or 6B. In at least one embodiment portions or all of inference and/or training logic 615 may be incorporated into graphics processor 1008. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 6A or 6B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

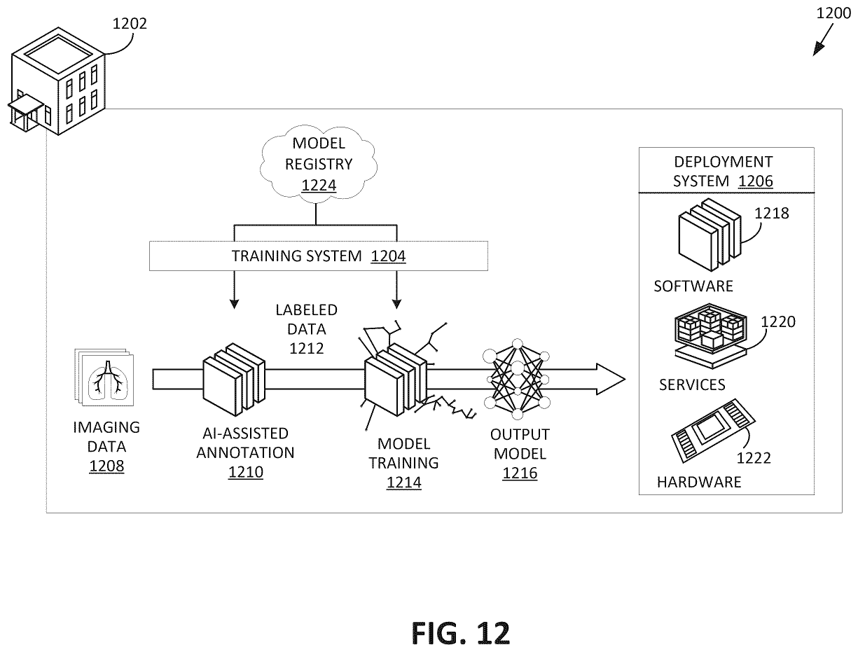

FIG. 11 is a block diagram of a processor 1100 having one or more processor cores 1102A-1102N, an integrated memory controller 1113, and an integrated graphics processor 1108, according to at least one embodiment. In at least one embodiment, processor 1100 may include additional cores up to and including additional core 1102N represented by dashed lined boxes. In at least one embodiment, each of processor cores 1102A-1102N includes one or more internal cache units 1104A-1104N. In at least one embodiment, each processor core also has access to one or more shared cached units 1106.

In at least one embodiment, internal cache units 1104A-1104N and shared cache units 1106 represent a cache memory hierarchy within processor 1100. In at least one embodiment, cache memory units 1104A-1104N may include at least one level of instruction and data cache within each processor core and one or more levels of shared mid-level cache, such as a Level 2 (L2), Level 3 (L3 ), Level 4 (L4 ), or other levels of cache, where a highest level of cache before external memory is classified as an LLC. In at least one embodiment, cache coherency logic maintains coherency between various cache units 1106 and 1104A-1104N.

In at least one embodiment, processor 1100 may also include a set of one or more bus controller units 1116 and a system agent core 1110. In at least one embodiment, one or more bus controller units 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1113 to manage access to various external memory devices (not shown).

In at least one embodiment, one or more of processor cores 1102A-1102N include support for simultaneous multi-threading. In at least one embodiment, system agent core 1110 includes components for coordinating and operating cores 1102A-1102N during multi-threaded processing. In at least one embodiment, system agent core 1110 may additionally include a power control unit (PCU), which includes logic and components to regulate one or more power states of processor cores 1102A-1102N and graphics processor 1108.

In at least one embodiment, processor 1100 additionally includes graphics processor 1108 to execute graphics processing operations. In at least one embodiment, graphics processor 1108 couples with shared cache units 1106, and system agent core 1110, including one or more integrated memory controllers 1113. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring interconnect 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor cores 1102A-1102N and graphics processor 1108 use embedded memory modules 1118 as a shared Last Level Cache.

In at least one embodiment, processor cores 1102A-1102N are homogenous cores executing a common instruction set architecture. In at least one embodiment, processor cores 1102A-1102N are heterogeneous in terms of instruction set architecture (ISA), where one or more of processor cores 1102A-1102N execute a common instruction set, while one or more other cores of processor cores 1102A-1102N executes a subset of a common instruction set or a different instruction set. In at least one embodiment, processor cores 1102A-1102N are heterogeneous in terms of microarchitecture, where one or more cores having a relatively higher power consumption couple with one or more power cores having a lower power consumption. In at least one embodiment, processor 1100 may be implemented on one or more chips or as a SoC integrated circuit.

Inference and/or training logic 615 are used to perform inferencing and/or training operations associated with one or more embodiments. Details regarding inference and/or training logic 615 are provided below in conjunction with FIGS. 6A and/or 6B. In at least one embodiment portions or all of inference and/or training logic 615 may be incorporated into processor 1100. For example, in at least one embodiment, training and/or inferencing techniques described herein may use one or more of ALUs embodied in graphics processor 1108, graphics core(s) 1102A-1102N, or other components in FIG. 11. Moreover, in at least one embodiment, inferencing and/or training operations described herein may be done using logic other than logic illustrated in FIG. 6A or 6B. In at least one embodiment, weight parameters may be stored in on-chip or off-chip memory and/or registers (shown or not shown) that configure ALUs of graphics processor 1100 to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

### Virtualized Computing Platform

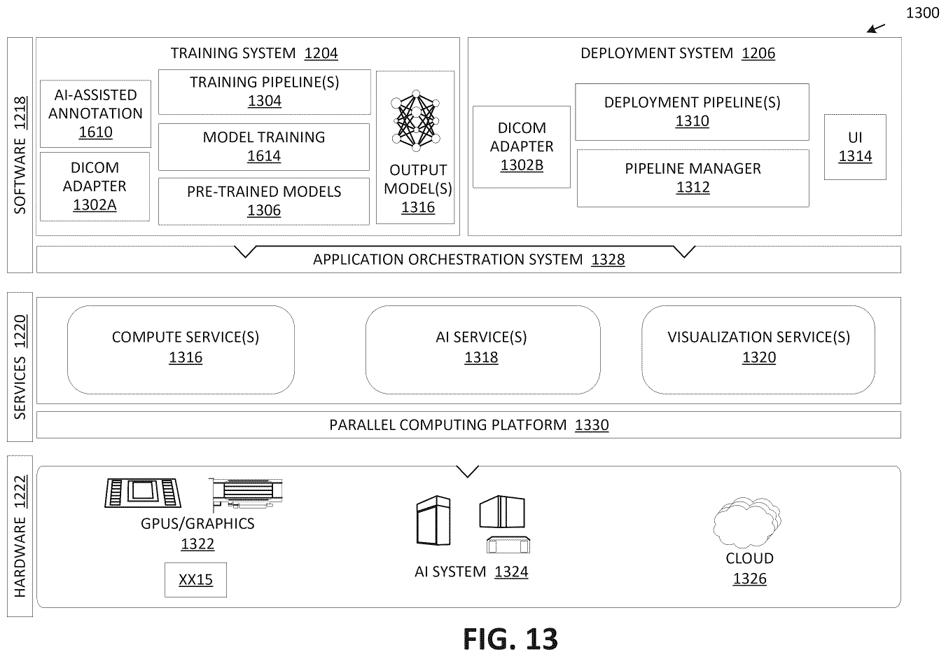

FIG. 12 is an example data flow diagram for a process 1200 of generating and deploying an image processing and inferencing pipeline, in accordance with at least one embodiment. In at least one embodiment, process 1200 may be deployed for use with imaging devices, processing devices, and/or other device types at one or more facilities 1202. Process 1200 may be executed within a training system 1204 and/or a deployment system 1206. In at least one embodiment, training system 1204 may be used to perform training, deployment, and implementation of machine learning models (e.g., neural networks, object detection algorithms, computer vision algorithms, etc.) for use in deployment system 1206. In at least one embodiment, deployment system 1206 may be configured to offload processing and compute resources among a distributed computing environment to reduce infrastructure requirements at facility 1202. In at least one embodiment, one or more applications in a pipeline may use or call upon services (e.g., inference, visualization, compute, AI, etc.) of deployment system 1206 during execution of applications.

In at least one embodiment, some of applications used in advanced processing and inferencing pipelines may use machine learning models or other AI to perform one or more processing steps. In at least one embodiment, machine learning models may be trained at facility 1202 using data 1208 (such as imaging data) generated at facility 1202 (and stored on one or more picture archiving and communication system (PACS) servers at facility 1202), may be trained using imaging or sequencing data 1208 from another facility(ies), or a combination thereof. In at least one embodiment, training system 1204 may be used to provide applications, services, and/or other resources for generating working, deployable machine learning models for deployment system 1206.

In at least one embodiment, model registry 1224 may be backed by object storage that may support versioning and object metadata. In at least one embodiment, object storage may be accessible through, for example, a cloud storage (e.g., cloud 1226 of FIG. 12) compatible application programming interface (API) from within a cloud platform. In at least one embodiment, machine learning models within model registry 1224 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1204 (FIG. 12) may include a scenario where facility 1202 is training their own machine learning model, or has an existing machine learning model that needs to be optimized or updated. In at least one embodiment, imaging data 1208 generated by imaging device(s), sequencing devices, and/or other device types may be received. In at least one embodiment, once imaging data 1208 is received, AI-assisted annotation 1210 may be used to aid in generating annotations corresponding to imaging data 1208 to be used as ground truth data for a machine learning model. In at least one embodiment, AI-assisted annotation 1210 may include one or more machine learning models (e.g., convolutional neural networks (CNNs)) that may be trained to generate annotations corresponding to certain types of imaging data 1208 (e.g., from certain devices). In at least one embodiment, AI-assisted annotations 1210 may then be used directly, or may be adjusted or fine-tuned using an annotation tool to generate ground truth data. In at least one embodiment, AI-assisted annotations 1210, labeled clinic data 1212, or a combination thereof may be used as ground truth data for training a machine learning model. In at least one embodiment, a trained machine learning model may be referred to as output model 1216, and may be used by deployment system 1206, as described herein.

In at least one embodiment, training pipeline 1204 (FIG. 12) may include a scenario where facility 1202 needs a machine learning model for use in performing one or more processing tasks for one or more applications in deployment system 1206, but facility 1202 may not currently have such a machine learning model (or may not have a model that is optimized, efficient, or effective for such purposes). In at least one embodiment, an existing machine learning model may be selected from a model registry 1224. In at least one embodiment, model registry 1224 may include machine learning models trained to perform a variety of different inference tasks on imaging data. In at least one embodiment, machine learning models in model registry 1224 may have been trained on imaging data from different facilities than facility 1202 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1224. In at least one embodiment, a machine learning model may then be retrained, or updated, at any number of other facilities, and a retrained or updated model may be made available in model registry 1224. In at least one embodiment, a machine learning model may then be selected from model registry 1224—and referred to as output model 1216—and may be used in deployment system 1206 to perform one or more processing tasks for one or more applications of a deployment system.

In at least one embodiment, training pipeline 1204 (FIG. 12), a scenario may include facility 1202 requiring a machine learning model for use in performing one or more processing tasks for one or more applications in deployment system 1206, but facility 1202 may not currently have such a machine learning model (or may not have a model that is optimized, efficient, or effective for such purposes). In at least one embodiment, a machine learning model selected from model registry 1224 may not be fine-tuned or optimized for imaging data 1208 generated at facility 1202 because of differences in populations, robustness of training data used to train a machine learning model, diversity in anomalies of training data, and/or other issues with training data. In at least one embodiment, AI-assisted annotation 1210 may be used to aid in generating annotations corresponding to imaging data 1208 to be used as ground truth data for retraining or updating a machine learning model. In at least one embodiment, labeled data 1212 may be used as ground truth data for training a machine learning model. In at least one embodiment, retraining or updating a machine learning model may be referred to as model training 1214. In at least one embodiment, model training 1214—e.g., AI-assisted annotations 1210, labeled clinic data 1212, or a combination thereof—may be used as ground truth data for retraining or updating a machine learning model. In at least one embodiment, a trained machine learning model may be referred to as output model 1216, and may be used by deployment system 1206, as described herein.

In at least one embodiment, deployment system 1206 may include software 1218, services 1220, hardware 1222, and/or other components, features, and functionality. In at least one embodiment, deployment system 1206 may include a software “stack,” such that software 1218 may be built on top of services 1220 and may use services 1220 to perform some or all of processing tasks, and services 1220 and software 1218 may be built on top of hardware 1222 and use hardware 1222 to execute processing, storage, and/or other compute tasks of deployment system 1206. In at least one embodiment, software 1218 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1208, in addition to containers that receive and configure imaging data for use by each container and/or for use by facility 1202 after processing through a pipeline (e.g., to convert outputs back to a usable data type). In at least one embodiment, a combination of containers within software 1218 (e.g., that make up a pipeline) may be referred to as a virtual instrument (as described in more detail herein), and a virtual instrument may leverage services 1220 and hardware 1222 to execute some or all processing tasks of applications instantiated in containers.

In at least one embodiment, a data processing pipeline may receive input data (e.g., imaging data 1208) in a specific format in response to an inference request (e.g., a request from a user of deployment system 1206). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1216 of training system 1204.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1224 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1220 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1200 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1200 of FIG. 12). In at least one embodiment, completed and validated applications or containers may be stored in a container registry and associated machine learning models may be stored in model registry 1224. In at least one embodiment, a requesting entity—who provides an inference or image processing request—may browse a container registry and/or model registry 1224 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1206 (e.g., a cloud) to perform processing of data processing pipeline. In at least one embodiment, processing by deployment system 1206 may include referencing selected elements (e.g., applications, containers, models, etc.) from a container registry and/or model registry 1224. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1220 may be leveraged. In at least one embodiment, services 1220 may include compute services, artificial intelligence (AI) services, visualization services, and/or other service types. In at least one embodiment, services 1220 may provide functionality that is common to one or more applications in software 1218, so functionality may be abstracted to a service that may be called upon or leveraged by applications. In at least one embodiment, functionality provided by services 1220 may run dynamically and more efficiently, while also scaling well by allowing applications to process data in parallel (e.g., using a parallel computing platform 1230 (FIG. 12)). In at least one embodiment, rather than each application that shares a same functionality offered by a service 1220 being required to have a respective instance of service 1220, service 1220 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1220 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1218 implementing advanced processing and inferencing pipeline that includes segmentation application and anomaly detection application may be streamlined because each application may call upon a same inference service to perform one or more inferencing tasks.

In at least one embodiment, hardware 1222 may include GPUs, CPUs, DPUs, graphics cards, an AI/deep learning system (e.g., an AI supercomputer, such as NVIDIA's DGX), a cloud platform, or a combination thereof. In at least one embodiment, different types of hardware 1222 may be used to provide efficient, purpose-built support for software 1218 and services 1220 in deployment system 1206. In at least one embodiment, use of GPU processing may be implemented for processing locally (e.g., at facility 1202), within an AI/deep learning system, in a cloud system, and/or in other processing components of deployment system 1206 to improve efficiency, accuracy, and efficacy of image processing and generation. In at least one embodiment, software 1218 and/or services 1220 may be optimized for GPU processing with respect to deep learning, machine learning, and/or high-performance computing, as non-limiting examples. In at least one embodiment, at least some of computing environment of deployment system 1206 and/or training system 1204 may be executed in a datacenter one or more supercomputers or high performance computing systems, with GPU optimized software (e.g., hardware and software combination of NVIDIA's DGX System). In at least one embodiment, hardware 1222 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform may further include DPU processing to transmit data received over a network and/or through a network controller or other network interface directly to (e.g., a memory of) one or more GPU(s). In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

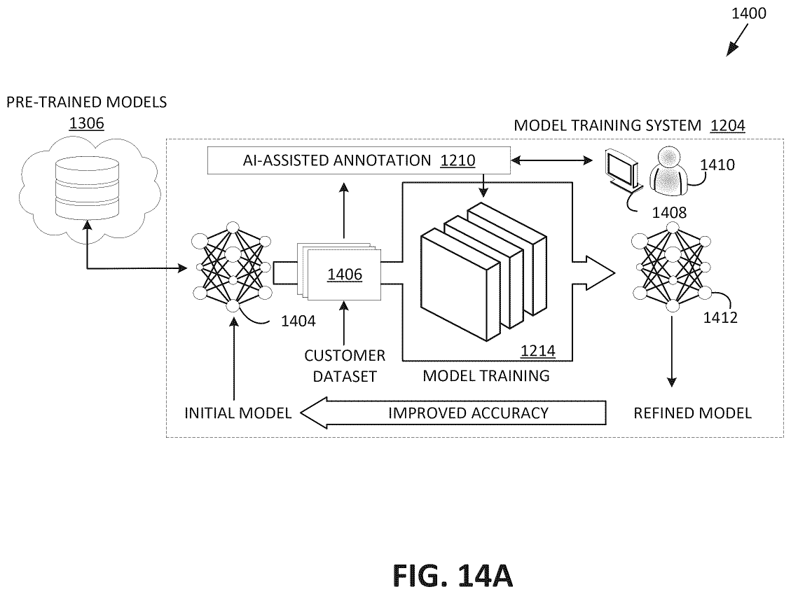

FIG. 13 is a system diagram for an example system 1300 for generating and deploying an imaging deployment pipeline, in accordance with at least one embodiment. In at least one embodiment, system 1300 may be used to implement process 1200 of FIG. 12 and/or other processes including advanced processing and inferencing pipelines. In at least one embodiment, system 1300 may include training system 1204 and deployment system 1206. In at least one embodiment, training system 1204 and deployment system 1206 may be implemented using software 1218, services 1220, and/or hardware 1222, as described herein.

In at least one embodiment, system 1300 (e.g., training system 1204 and/or deployment system 1206) may implemented in a cloud computing environment (e.g., using cloud 1326). In at least one embodiment, system 1300 may be implemented locally with respect to a healthcare services facility, or as a combination of both cloud and local computing resources. In at least one embodiment, access to APIs in cloud 1326 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1300, may be restricted to a set of public IPs that have been vetted or authorized for interaction.

In at least one embodiment, various components of system 1300 may communicate between and among one another using any of a variety of different network types, including but not limited to local area networks (LANs) and/or wide area networks (WANs) via wired and/or wireless communication protocols. In at least one embodiment, communication between facilities and components of system 1300 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1204 may execute training pipelines 1304, similar to those described herein with respect to FIG. 12. In at least one embodiment, where one or more machine learning models are to be used in deployment pipelines 1310 by deployment system 1206, training pipelines 1304 may be used to train or retrain one or more (e.g., pre-trained) models, and/or implement one or more of pre-trained models 1306 (e.g., without a need for retraining or updating). In at least one embodiment, as a result of training pipelines 1304, output model(s) 1216 may be generated. In at least one embodiment, training pipelines 1304 may include any number of processing steps, such as but not limited to imaging data (or other input data) conversion or adaption In at least one embodiment, for different machine learning models used by deployment system 1206, different training pipelines 1304 may be used. In at least one embodiment, training pipeline 1304 similar to a first example described with respect to FIG. 12 may be used for a first machine learning model, training pipeline 1304 similar to a second example described with respect to FIG. 12 may be used for a second machine learning model, and training pipeline 1304 similar to a third example described with respect to FIG. 12 may be used for a third machine learning model. In at least one embodiment, any combination of tasks within training system 1204 may be used depending on what is required for each respective machine learning model. In at least one embodiment, one or more of machine learning models may already be trained and ready for deployment so machine learning models may not undergo any processing by training system 1204, and may be implemented by deployment system 1206.

In at least one embodiment, output model(s) 1216 and/or pre-trained model(s) 1306 may include any types of machine learning models depending on implementation or embodiment. In at least one embodiment, and without limitation, machine learning models used by system 1300 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1304 may include AI-assisted annotation, as described in more detail herein with respect to at least FIG. 12B. In at least one embodiment, labeled data 1212 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1208 (or other data type used by machine learning models), there may be corresponding ground truth data generated by training system 1204. In at least one embodiment, AI-assisted annotation may be performed as part of deployment pipelines 1310; either in addition to, or in lieu of AI-assisted annotation included in training pipelines 1304. In at least one embodiment, system 1300 may include a multi-layer platform that may include a software layer (e.g., software 1218) of diagnostic applications (or other application types) that may perform one or more medical imaging and diagnostic functions. In at least one embodiment, system 1300 may be communicatively coupled to (e.g., via encrypted links) PACS server networks of one or more facilities. In at least one embodiment, system 1300 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1202). In at least one embodiment, applications may then call or execute one or more services 1220 for performing compute, AI, or visualization tasks associated with respective applications, and software 1218 and/or services 1220 may leverage hardware 1222 to perform processing tasks in an effective and efficient manner.

In at least one embodiment, deployment system 1206 may execute deployment pipelines 1310. In at least one embodiment, deployment pipelines 1310 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1310 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1310 depending on information desired from data generated by a device. In at least one embodiment, where detections of anomalies are desired from an MRI machine, there may be a first deployment pipeline 1310, and where image enhancement is desired from output of an MRI machine, there may be a second deployment pipeline 1310.

In at least one embodiment, an image generation application may include a processing task that includes use of a machine learning model. In at least one embodiment, a user may desire to use their own machine learning model, or to select a machine learning model from model registry 1224. In at least one embodiment, a user may implement their own machine learning model or select a machine learning model for inclusion in an application for performing a processing task. In at least one embodiment, applications may be selectable and customizable, and by defining constructs of applications, deployment, and implementation of applications for a particular user are presented as a more seamless user experience. In at least one embodiment, by leveraging other features of system 1300—such as services 1220 and hardware 1222—deployment pipelines 1310 may be even more user friendly, provide for easier integration, and produce more accurate, efficient, and timely results. One or more embodiments of the application may be implemented as, or to include a game, a video streaming application, a machine control application, a machine locomotion application, a machine driving application, a synthetic data generation application, a model training application, a perception application, an augmented reality application, a virtual reality application, a mixed reality application, a robotics application, a security and surveillance application, an autonomous or semi-autonomous machine application, a deep learning application, an environment simulation application, a data center processing application, a conversational AI application, a light transport simulation application (e.g., ray tracing, path tracing, etc.), a collaborative content creation application for 3D assets, a digital twin system application, a cloud computing application and/or another type of application or service.

In at least one embodiment, deployment system 1206 may include a user interface 1314 (e.g., a graphical user interface, a web interface, etc.) that may be used to select applications for inclusion in deployment pipeline(s) 1310, arrange applications, modify, or change applications or parameters or constructs thereof, use and interact with deployment pipeline(s) 1310 during set-up and/or deployment, and/or to otherwise interact with deployment system 1206. In at least one embodiment, although not illustrated with respect to training system 1204, user interface 1314 (or a different user interface) may be used for selecting models for use in deployment system 1206, for selecting models for training, or retraining, in training system 1204, and/or for otherwise interacting with training system 1204.

In at least one embodiment, pipeline manager 1312 may be used, in addition to an application orchestration system 1328, to manage interaction between applications or containers of deployment pipeline(s) 1310 and services 1220 and/or hardware 1222. In at least one embodiment, pipeline manager 1312 may be configured to facilitate interactions from application to application, from application to service 1220, and/or from application or service to hardware 1222. In at least one embodiment, although illustrated as included in software 1218, this is not intended to be limiting, and in some examples (e.g., as illustrated in FIG. 11) pipeline manager 1312 may be included in services 1220. In at least one embodiment, application orchestration system 1328 (e.g., Kubernetes, DOCKER, etc.) may include a container orchestration system that may group applications into containers as logical units for coordination, management, scaling, and deployment. In at least one embodiment, by associating applications from deployment pipeline(s) 1310 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1312 and application orchestration system 1328. In at least one embodiment, so long as an expected input and/or output of each container or application is known by a system (e.g., based on constructs of applications or containers), application orchestration system 1328 and/or pipeline manager 1312 may facilitate communication among and between, and sharing of resources among and between, each of applications or containers. In at least one embodiment, because one or more of applications or containers in deployment pipeline(s) 1310 may share same services and resources, application orchestration system 1328 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1328) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1220 leveraged by and shared by applications or containers in deployment system 1206 may include compute services 1316, AI services 1318, visualization services 1320, and/or other service types. In at least one embodiment, applications may call (e.g., execute) one or more of services 1220 to perform processing operations for an application. In at least one embodiment, compute services 1316 may be leveraged by applications to perform super-computing or other high-performance computing (HPC) tasks. In at least one embodiment, compute service(s) 1316 may be leveraged to perform parallel processing (e.g., using a parallel computing platform 1330) for processing data through one or more of applications and/or one or more tasks of a single application, substantially simultaneously. In at least one embodiment, parallel computing platform 1330 (e.g., NVIDIA's CUDA) may enable general purpose computing on GPUs (GPGPU) (e.g., GPUs 1322). In at least one embodiment, a software layer of parallel computing platform 1330 may provide access to virtual instruction sets and parallel computational elements of GPUs, for execution of compute kernels. In at least one embodiment, parallel computing platform 1330 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1330 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1318 may be leveraged to perform inferencing services for executing machine learning model(s) associated with applications (e.g., tasked with performing one or more processing tasks of an application). In at least one embodiment, AI services 1318 may leverage AI system 1324 to execute machine learning model(s) (e.g., neural networks, such as CNNs) for segmentation, reconstruction, object detection, feature detection, classification, and/or other inferencing tasks. In at least one embodiment, applications of deployment pipeline(s) 1310 may use one or more of output models 1216 from training system 1204 and/or other models of applications to perform inference on imaging data. In at least one embodiment, two or more examples of inferencing using application orchestration system 1328 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1328 may distribute resources (e.g., services 1220 and/or hardware 1222) based on priority paths for different inferencing tasks of AI services 1318.

In at least one embodiment, shared storage may be mounted to AI services 1318 within system 1300. In at least one embodiment, shared storage may operate as a cache (or other storage device type) and may be used to process inference requests from applications. In at least one embodiment, when an inference request is submitted, a request may be received by a set of API instances of deployment system 1206, and one or more instances may be selected (e.g., for best fit, for load balancing, etc.) to process a request. In at least one embodiment, to process a request, a request may be entered into a database, a machine learning model may be located from model registry 1224 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1312) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<12 min). In at least one embodiment, model execution times may be measured from requesting institution or entity and may include partner network traversal time, as well as execution on an inference service.

In at least one embodiment, transfer of requests between services 1220 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1326, and an inference service may perform inferencing on a GPU.

In at least one embodiment, visualization services 1320 may be leveraged to generate visualizations for viewing outputs of applications and/or deployment pipeline(s) 1310. In at least one embodiment, GPUs 1322 may be leveraged by visualization services 1320 to generate visualizations. In at least one embodiment, rendering effects, such as ray-tracing, may be implemented by visualization services 1320 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1320 may include an internal visualizer, cinematics, and/or other rendering or image processing capabilities or functionality (e.g., ray tracing, rasterization, internal optics, etc.).

In at least one embodiment, hardware 1222 may include GPUs 1322, AI system 1324, cloud 1326, and/or any other hardware used for executing training system 1204 and/or deployment system 1606. In at least one embodiment, GPUs 1322 (e.g., NVIDIA's TESLA and/or QUADRO GPUs) may include any number of GPUs that may be used for executing processing tasks of compute services 1316, AI services 1318, visualization services 1320, other services, and/or any of features or functionality of software 1218. For example, with respect to AI services 1318, GPUs 1322 may be used to perform pre-processing on imaging data (or other data types used by machine learning models), post-processing on outputs of machine learning models, and/or to perform inferencing (e.g., to execute machine learning models). In at least one embodiment, cloud 1326, AI system 1324, and/or other components of system 1300 may use GPUs 1322. In at least one embodiment, cloud 1326 may include a GPU-optimized platform for deep learning tasks. In at least one embodiment, AI system 1324 may use GPUs, and cloud 1326—or at least a portion tasked with deep learning or inferencing—may be executed using one or more AI systems 1324. As such, although hardware 1222 is illustrated as discrete components, this is not intended to be limiting, and any components of hardware 1222 may be combined with, or leveraged by, any other components of hardware 1222.

In at least one embodiment, AI system 1324 may include a purpose-built computing system (e.g., a super-computer or an HPC) configured for inferencing, deep learning, machine learning, and/or other artificial intelligence tasks. In at least one embodiment, AI system 1324 (e.g., NVIDIA's DGX) may include GPU-optimized software (e.g., a software stack) that may be executed using a plurality of GPUs 1322, in addition to DPUs, CPUs, RAM, storage, and/or other components, features, or functionality. In at least one embodiment, one or more AI systems 1324 may be implemented in cloud 1326 (e.g., in a data center) for performing some or all of AI-based processing tasks of system 1300.

In at least one embodiment, cloud 1326 may include a GPU-accelerated infrastructure (e.g., NVIDIA's NGC) that may provide a GPU-optimized platform for executing processing tasks of system 1300. In at least one embodiment, cloud 1326 may include an AI system(s) 1324 for performing one or more of AI-based tasks of system 1300 (e.g., as a hardware abstraction and scaling platform). In at least one embodiment, cloud 1326 may integrate with application orchestration system 1328 leveraging multiple GPUs to enable seamless scaling and load balancing between and among applications and services 1220. In at least one embodiment, cloud 1326 may tasked with executing at least some of services 1220 of system 1300, including compute services 1316, AI services 1318, and/or visualization services 1320, as described herein. In at least one embodiment, cloud 1326 may perform small and large batch inference (e.g., executing NVIDIA's TENSOR RT), provide an accelerated parallel computing API and platform 1330 (e.g., NVIDIA's CUDA), execute application orchestration system 1328 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1300.

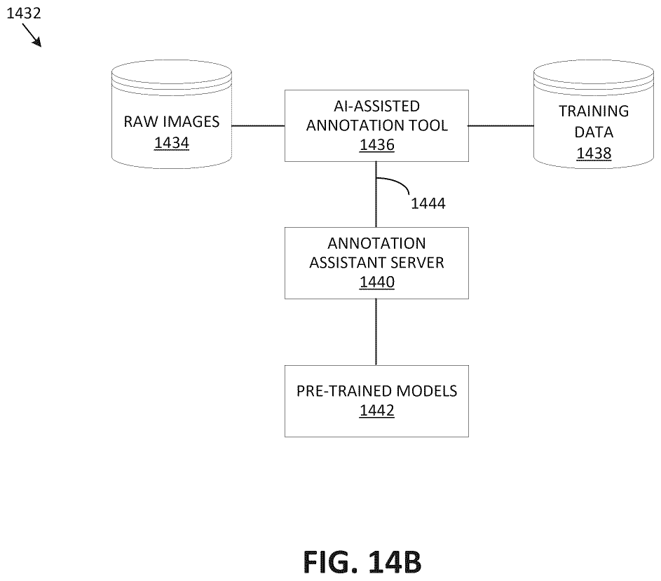

FIG. 14A illustrates a data flow diagram for a process 1400 to train, retrain, or update a machine learning model, in accordance with at least one embodiment. In at least one embodiment, process 1400 may be executed using, as a non-limiting example, system 1300 of FIG. 13. In at least one embodiment, process 1400 may leverage services 1220 and/or hardware 1222 of system 1300, as described herein. In at least one embodiment, refined models 1412 generated by process 1400 may be executed by deployment system 1206 for one or more containerized applications in deployment pipelines 1310.

In at least one embodiment, model training 1214 may include retraining or updating an initial model 1404 (e.g., a pre-trained model) using new training data (e.g., new input data, such as customer dataset 1406, and/or new ground truth data associated with input data). In at least one embodiment, to retrain, or update, initial model 1404, output or loss layer(s) of initial model 1404 may be reset, or deleted, and/or replaced with an updated or new output or loss layer(s). In at least one embodiment, initial model 1404 may have previously fine-tuned parameters (e.g., weights and/or biases) that remain from prior training, so training or retraining 1214 may not take as long or require as much processing as training a model from scratch. In at least one embodiment, during model training 1214, by having reset or replaced output or loss layer(s) of initial model 1404, parameters may be updated and re-tuned for a new data set based on loss calculations associated with accuracy of output or loss layer(s) at generating predictions on new, customer dataset 1406 (e.g., image data 1208 of FIG. 12).

In at least one embodiment, pre-trained models 1306 may be stored in a data store, or registry (e.g., model registry 1224 of FIG. 12). In at least one embodiment, pre-trained models 1306 may have been trained, at least in part, at one or more facilities other than a facility executing process 1400. In at least one embodiment, to protect privacy and rights of patients, subjects, or clients of different facilities, pre-trained models 1306 may have been trained, on-premise, using customer or patient data generated on-premise. In at least one embodiment, pre-trained models 1306 may be trained using cloud 1326 and/or other hardware 1222, but confidential, privacy protected patient data may not be transferred to, used by, or accessible to any components of cloud 1326 (or other off premise hardware). In at least one embodiment, where a pre-trained model 1306 is trained at using patient data from more than one facility, pre-trained model 1306 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1306 on-premise and/or off premise, such as in a datacenter or other cloud computing infrastructure.

In at least one embodiment, when selecting applications for use in deployment pipelines 1310, a user may also select machine learning models to be used for specific applications. In at least one embodiment, a user may not have a model for use, so a user may select a pre-trained model 1306 to use with an application. In at least one embodiment, pre-trained model 1306 may not be optimized for generating accurate results on customer dataset 1406 of a facility of a user (e.g., based on patient diversity, demographics, types of medical imaging devices used, etc.). In at least one embodiment, prior to deploying pre-trained model 1306 into deployment pipeline 1310 for use with an application(s), pre-trained model 1306 may be updated, retrained, and/or fine-tuned for use at a respective facility.

In at least one embodiment, a user may select pre-trained model 1306 that is to be updated, retrained, and/or fine-tuned, and pre-trained model 1306 may be referred to as initial model 1404 for training system 1204 within process 1400. In at least one embodiment, customer dataset 1406 (e.g., imaging data, genomics data, sequencing data, or other data types generated by devices at a facility) may be used to perform model training 1214 (which may include, without limitation, transfer learning) on initial model 1404 to generate refined model 1412. In at least one embodiment, ground truth data corresponding to customer dataset 1406 may be generated by training system 1204. In at least one embodiment, ground truth data may be generated, at least in part, by clinicians, scientists, doctors, practitioners, at a facility (e.g., as labeled clinic data 1212 of FIG. 12).

In at least one embodiment, AI-assisted annotation 1210 may be used in some examples to generate ground truth data. In at least one embodiment, AI-assisted annotation 1210 (e.g., implemented using an AI-assisted annotation SDK) may leverage machine learning models (e.g., neural networks) to generate suggested or predicted ground truth data for a customer dataset. In at least one embodiment, user 1410 may use annotation tools within a user interface (a graphical user interface (GUI)) on computing device 1408.

In at least one embodiment, user 1410 may interact with a GUI via computing device 1408 to edit or fine-tune (auto)annotations. In at least one embodiment, a polygon editing feature may be used to move vertices of a polygon to more accurate or fine-tuned locations.

In at least one embodiment, once customer dataset 1406 has associated ground truth data, ground truth data (e.g., from AI-assisted annotation, manual labeling, etc.) may be used by during model training 1214 to generate refined model 1412. In at least one embodiment, customer dataset 1406 may be applied to initial model 1404 any number of times, and ground truth data may be used to update parameters of initial model 1404 until an acceptable level of accuracy is attained for refined model 1412. In at least one embodiment, once refined model 1412 is generated, refined model 1412 may be deployed within one or more deployment pipelines 1210 at a facility for performing one or more processing tasks with respect to medical imaging data.

In at least one embodiment, refined model 1412 may be uploaded to pre-trained models 1206 in model registry 1224 to be selected by another facility. In at least one embodiment, his process may be completed at any number of facilities such that refined model 1412 may be further refined on new datasets any number of times to generate a more universal model.

FIG. 14B is an example illustration of a client-server architecture 1432 to enhance annotation tools with pre-trained annotation models, in accordance with at least one embodiment. In at least one embodiment, AI-assisted annotation tools 1436 may be instantiated based on a client-server architecture 1432. In at least one embodiment, annotation tools 1436 in imaging applications may aid radiologists, for example, identify organs and abnormalities. In at least one embodiment, imaging applications may include software tools that help user 1410 to identify, as a non-limiting example, a few extreme points on a particular organ of interest in raw images 1434 (e.g., in a 3D MRI or CT scan) and receive auto-annotated results for all 2D slices of a particular organ. In at least one embodiment, results may be stored in a data store as training data 1438 and used as (for example and without limitation) ground truth data for training. In at least one embodiment, when computing device 1408 sends extreme points for AI-assisted annotation 1210, a deep learning model, for example, may receive this data as input and return inference results of a segmented organ or abnormality. In at least one embodiment, pre-instantiated annotation tools, such as AI-Assisted Annotation Tool 1436B in FIG. 14B, may be enhanced by making API calls (e.g., API Call 1444) to a server, such as an Annotation Assistant Server 1440 that may include a set of pre-trained models 1442 stored in an annotation model registry, for example. In at least one embodiment, an annotation model registry may store pre-trained models 1442 (e.g., machine learning models, such as deep learning models) that are pre-trained to perform AI-assisted annotation on a particular organ or abnormality. These models may be further updated by using training pipelines 1304. In at least one embodiment, pre-installed annotation tools may be improved over time as new labeled clinic data 1212 is added.

Such components may be used to generate synthetic data imitating failure cases in a network training process, which may help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising,
obtaining, from at least one of a first node of a plurality of nodes of a computing environment or a second node of the plurality of nodes, first audit data associated with a first operation performed in accordance with a request by an application running in the computing environment and second audit data associated with a second operation performed in accordance with the request by the application;
updating an audit log associated with the plurality of nodes to include a mapping between the first audit data, the second audit data, and an audit identifier associated with the request by the application;
responsive to an audit request for audit data associated with the request by the application, identifying the first audit data and the second audit data from the audit log based on the mapping; and
providing the first audit data and the second audit data to a client device associated with the computing environment in accordance with the audit request.

2. The method of claim 1, wherein identifying the first audit data and the second audit data from the audit log based on mapping comprises:
determining the audit identifier associated with the request issued by the application;
identifying one or more entries of the audit log associated with the audit identifier, the one or more entries comprising the mapping between the audit identifier, the first audit data, and the second audit data; and
extracting the first audit data and the second audit data from the identified one or more entries.

3. The method of claim 1, further comprising:
receiving the audit request from the client device associated with the computing environment for one or more sets of audit data associated with requests by one or more applications running in the computing environment.

4. The method of claim 1, further comprising:
receiving the audit request from a computing system of the computing environment in accordance with a routine audit protocol for the computing environment.

5. The method of claim 1, wherein the first operation is performed by a first microservice of the computing environment and the second operation is performed by a second microservice of the computing environment.

6. The method of claim 5, wherein the first node comprises a first collection of computing resources that run at least a portion of the first microservice and the second node comprises a second collection of computing resources that run at least a portion of the second microservice.

7. The method of claim 1, wherein the first audit data comprises at least one of an indication of the first operation performed for a first object, an indication of a state of the first object prior to the performance of the first operation, or an indication of a state of the first object after the performance of the first operation and wherein the second audit data comprises at least one of an indication of the second operation performed for a second object, an indication of a state of the second object prior to the performance of the second operation, or an indication of a state of the second object after the performance of the second operation.

8. The method of claim 1, wherein the computing environment is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional (3D) assets;
a system for performing deep learning operations;
a system implemented using an edge device;
a system implemented using a robot;
a system for performing conversational AI operations;
a system for performing operations using a large language model (LLM);
a system for performing synthetic data generation;
a system for generating synthetic data;
a system for presenting at least one of virtual reality content, augmented reality content, or mixed reality content;
a system implemented at least partially in a data center; or
a system implemented at least partially using cloud computing resources.

9. A system comprising:
one or more processing devices to perform operations comprising:
obtaining, from at least one of a first node of a plurality of nodes of a computing environment or a second node of the plurality of nodes, first audit data associated with a first operation performed in accordance with a request by an application running in the computing environment and second audit data associated with a second operation performed in accordance with the request by the application;
updating an audit log associated with the plurality of nodes to include a mapping between the first audit data, the second audit data, and an audit identifier associated with the request by the application;
responsive to an audit request for audit data associated with the request by the application, identifying the first audit data and the second audit data from the audit log based on the mapping; and
providing the first audit data and the second audit data to a client device associated with the computing environment in accordance with the audit request.

10. The system of claim 9, wherein identifying the first audit data and the second audit data from the audit log based on mapping comprises:
determining the audit identifier associated with the request issued by the application;
identifying one or more entries of the audit log associated with the audit identifier, the one or more entries comprising the mapping between the audit identifier, the first audit data, and the second audit data; and
extracting the first audit data and the second audit data from the identified one or more entries.

11. The system of claim 9, wherein the operations further comprise:
receiving the audit request from the client device associated with the computing environment for one or more sets of audit data associated with requests by one or more applications running in the computing environment.

12. The system of claim 9, wherein the operations further comprise:
receiving the audit request from a computing system of the computing environment in accordance with a routine audit protocol for the computing environment.

13. The system of claim 9, wherein the first operation is performed by a first microservice of the computing environment and the second operation is performed by a second microservice of the computing environment.

14. The system of claim 13, wherein the first node comprises a first collection of computing resources that run at least a portion of the first microservice and the second node comprises a second collection of computing resources that run at least a portion of the second microservice.

15. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional (3D) assets;
a system for performing deep learning operations;
a system implemented using an edge device;
a system implemented using a robot;
a system for performing conversational AI operations;
a system for performing operations using a large language model (LLM);
a system for performing synthetic data generation;
a system for generating synthetic data;
a system for presenting at least one of virtual reality content, augmented reality content, or mixed reality content;
a system implemented at least partially in a data center; or
a system implemented at least partially using cloud computing resources.

16. A processor comprising one or more processing units to:
obtain, from at least one of a first node of a plurality of nodes of a computing environment or a second node of the plurality of nodes, first audit data associated with a first operation performed in accordance with a request by an application running in the computing environment and second audit data associated with a second operation performed in accordance with the request by the application;
update an audit log associated with the plurality of nodes to include a mapping between the first audit data, the second audit data, and an audit identifier associated with the request by the application;
responsive to an audit request for audit data associated with the request by the application, identify the first audit data and the second audit data from the audit log based on the mapping; and
provide the first audit data and the second audit data to a client device associated with the computing environment in accordance with the audit request.

17. The processor of claim 16, wherein identifying the first audit data and the second audit data from the audit log based on mapping comprises:
determining the audit identifier associated with the request issued by the application;
identifying one or more entries of the audit log associated with the audit identifier, the one or more entries comprising the mapping between the audit identifier, the first audit data, and the second audit data; and
extracting the first audit data and the second audit data from the identified one or more entries.

18. The processor of claim 16, wherein the processing units are further to:
receive the audit request from the client device associated with the computing environment for one or more sets of audit data associated with requests by one or more applications running in the computing environment.

19. The processor of claim 16, wherein the processing units are further to:
receive the audit request from a computing system of the computing environment in accordance with a routine audit protocol for the computing environment.

20. The processor of claim 16, wherein the first operation is performed by a first microservice of the computing environment and the second operation is performed by a second microservice of the computing environment.
